(19) United States
(12) Patent Application Publication
(10) Pub. No.: US 2023/0108819 A1
(43) Pub. Date: Apr. 6, 2023

(54) AUTOMATED PROCESSES AND SYSTEMS FOR MANAGING AND TROUBLESHOOTING SERVICES IN A DISTRIBUTED COMPUTING SYSTEM

(71) Applicant: VMware, Inc., Palo Alto, CA (US)

(72) Inventors: Karen Aghajanyan, Yerevan (AM); Nshan Sharoyan, Yerevan (AM); Areg Hovhannisyan, Yerevan (AM); Ashot Nshan Harutyunyan, Yerevan (AM); Atnak Poghosyan, Yerevan (AM); Naira Movses Grigoryan, Yerevan (AM); Tigran Matevosyan, Yerevan (AM); Lilit Arakelyan, Yerevan (AM)

(73) Assignee: VMware, Inc., Palo Alto, CA (US)

(21) Appl. No.: 17/493,633

(22) Filed: Oct. 4, 2021

(51) Int. Cl. G06Q 10/06; G06F 16/245; G06F 11/07

(52) U.S. Cl. CPC G06Q 10/06393; G06F 16/245; G06F 11/079; G06F 11/0709; G06F 3/04847

(57) ABSTRACT

Automated computer-implemented processes and systems manage and troubleshoot a service provided by a distributed application executing in a distributed computing system. Processes query objects of the distributed computing system to identify candidate objects for addition to the service. Processes generate recommendations in a graphical user interface (“GUI”) that enable a user to select and enroll the one or more candidate objects into the service via the GUI. Processes monitor a key performance indicator (“KPI”) of the service for violations of a corresponding service level object (“SLO”) threshold. When the KPI violates the SLO threshold, processes determine a root cause of a performance problem with the service based on a metric-association rule associated with the KPI violation of the SLO threshold and displays the performance problem and a recommendation that corrects the performance problem in a GUI.

### TECHNICAL FIELD

This disclosure is directed to managing services and troubleshooting problems associated with the services executed in a data center.

### BACKGROUND

Electronic computing has evolved from primitive, vacuum-tube-based computer systems, initially developed during the 1940s, to modern electronic computing systems in which large numbers of multi-processor computer systems, such as server computers and workstations, are networked together with large-capacity data-storage devices to produce geographically distributed computing systems that provide enormous computational bandwidths and data-storage capacities. These large distributed computing systems include data centers and are made possible by advancements in computer networking, distributed operating systems and applications, data-storage appliances, computer hardware, and software technologies. The number and size of data centers has grown in recent years to meet the increasing demand for information technology (“IT”) services, such as running applications for organizations that provide business services, web services, and other cloud services to millions of users each day.

Advancements in virtualization and software technologies provide many advantages for development and deployment of applications in data centers. Enterprises, governments, and other organizations now conduct commerce, provide services over the Internet, and process large volumes of data using distributed applications executed in data centers. A distributed application comprises multiple software components that are executed on one or more server computers. Each software component communicates and coordinates actions with other software components and data stores to appear as a single coherent application that provides services to an end user. Consider, for example, a distributed application that provides banking services to users via a bank website or a mobile application (“mobile app”) executed on a mobile device. One software component provides front-end services that enable users to input banking requests and receive responses to requests via the website or the mobile app. Each user only sees the features provided by the website or mobile app. Other software components of the distributed application provide back-end services that are executed across a distributed computing system. These services include processing user banking requests, maintaining storage of user banking information in data stores, and retrieving user information from data stores.

Organizations that depend on data centers to run their applications cannot afford performance problems that result in downtime or slow execution of their applications. Performance problems frustrate users, damage a brand name, result in lost revenue, and, in some cases, deny people access to vital services. As a result, management tools have been developed to aid system administrators and software engineers monitor, troubleshoot, and manage the health and capacity of applications deployed in data centers. However, typical management tools do not eliminate certain operations that must be performed manually by administrators and software engineers. For example, typical management tools only discover known services provided by data center objects, such as hosts, virtual machines (“VMs”), data stores, containers, and network devices, that are already listed in an object documentation list. New services provided by objects must be discovered and added manually to a known service. Typical management tools discover services when a service is communicating on a port. However, the port must be a standard port or be defined when added manually. In addition, typical management tools cannot discover services on a VM having multiple IP address, cannot discover services if there is a connection or user authentication failure problem with a VM, and cannot discover relationships or connections between VMs deployed across different server computers. Because creation and discovery of services in certain cases must be performed manually, the process of creating a service and discovering services that can be added to existing services is time consuming and error prone.

Management tools have also been developed to aid with troubleshooting performance problems in applications running in data centers. Teams of software engineers use management tools to aid with troubleshooting performance problems of applications based on manual workflows and domain experience. However, even with the aid of typical management tools, the troubleshooting process performed by software engineers is error prone and can take weeks and, in some cases, months to determine the root cause of a problem. Long periods spent by engineers troubleshooting an application performance problem increases costs for organizations and can result in unresolved errors in processing transactions and denying people access to services provided by an organization for long periods. Software engineers, data center administrators, and organizations that deploy applications in data centers seek processes and systems that create, discover, and manage services by reducing the time and increasing the accuracy of identifying root causes of performance problems in applications running in data centers.

### SUMMARY

Automated computer-implemented processes and systems described herein are directed to managing and troubleshooting a service provided by a distributed application executed in a distributed computing system. An automated computer-implemented process queries objects of the distributed computing system to identify candidate objects for addition to the service based on metadata of the candidate objects or run-time netflows between the candidate objects and objects of the distributed application. The computer-implemented process generates recommendations in a graphical user interface (“GUI”) that enables a user to enroll the one or more candidate objects into the service. One or more of the candidate objects are enrolled into the service in response to a user selecting candidate objects via the GUI. The computer-implemented process monitors a key performance indicator (“KPI”) of the service for violations of a corresponding service level object (“SLO”) threshold. In response to the computer-implemented process detecting the KPI violation of the SLO threshold at run time, the process determines a root cause of a performance problem with the service based on a metric-association rule associated with the KPI violation of the SLO threshold. The metric-association rule identifies combinations of metrics that correspond to resources and/or objects that exhibit abnormal behavior in a run-time interval and are the root cause of the performance problem. The root cause of the performance problem and a recommendation that corrects the performance problem are displayed in a GUI.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine (“VM”) and VM execution environments.

FIG. 6 shows an example of an open virtualization format package.

FIG. 7 shows virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a distributed computing system comprising a virtualization layer and a physical data center.

FIGS. 14A-14B show examples of a operations manager that receives object information from various objects.

FIG. 15 shows an example of tiers of a distributed application.

FIG. 16 shows an example architecture of ten VMs.

FIGS. 17A-17D show examples of metadata.

FIGS. 18A-18B show an example architecture of the ten VMs and corresponding tags.

FIG. 19 shows an example graphical user interface (“GUI”) that recommends objects for addition to a service of a distributed application.

FIGS. 20A-20B show an example VM and datastore enrolled in a service provided by a distributed application.

FIG. 21A shows an example architecture of eleven VMs and five datastores.

FIG. 21B shows an example plot of total number of packets sent to and from a VM over time.

FIG. 21C shows an example plot of datastores over time.

FIG. 22 shows an example GUI that recommends objects for addition to a service of a distributed application.

FIGS. 23A-23B show an example VM and datastore enrolled in a service provided by a distributed application.

FIG. 24 shows an example of object information sent to an operations manager.

FIG. 25 shows a plot of an example metric.

FIG. 26 show a plot of an example property metric.

FIGS. 27A-27F show plots of example metrics and associated dynamic thresholds.

FIG. 28 shows a plot of an example anomaly count metric.

FIG. 29A shows a plot of an example anomaly count metric.

FIG. 29B shows a plot of incremental changes in the anomaly counts of FIG. 29A.

FIGS. 30A-30C show an example of determining unacceptable incremental changes across tiers and an object of a tier.

FIG. 31 shows a plot of an example metric and four thresholds.

FIG. 32 shows two relative frequencies distributions of two adjacent run-time intervals.

FIGS. 33A-33B show examples of GUIs that enable a user to selected alert levels and durations of threshold violations.

FIG. 34 shows an example of a GUI of metrics.

FIG. 35 shows a plot of an example KPI.

FIG. 36 shows plots of example metrics.

FIG. 37 shows time stamps of KPI and metric threshold violations.

FIG. 38 shows time stamps of KPI and metric threshold violations.

FIG. 39 shows time axes of five metrics with marks identifying time stamps that correspond to threshold violations.

FIG. 40 shows an example of combinations of metric created from threshold violations in FIG. 39.

FIG. 41 shows a table of the combinations of metrics and time stamps identified in FIG. 40.

FIGS. 42A-42C show an example of metric-association rules.

FIG. 43 shows plots of an example metric and an example KPI.

FIG. 44 shows a two-dimensional space that contains a set of metric and KPI tuples.

FIG. 45 shows a table of example metric-association rules, performance problems and recommendations for correcting the performance problems.

FIG. 46 is a flow diagram of a method for managing a service provided by a distributed application running in a distributed computing system.

FIG. 47 is a flow diagram illustrating an example implementation of the “query objects for addition to the service” procedure performed in FIG. 46.

FIG. 48 is a flow diagram illustrating an example implementation of the “monitor a KPI of the service for violation of an SLO threshold” procedure performed in FIG. 46.

FIG. 49 is a flow diagram illustrating an example implementation of the “determine a metric-association rule” procedure performed in FIG. 48.

FIG. 50 is a flow diagram illustrating an example implementation of the “determine metric-association rules based on combinations of metrics of interest” procedure performed in FIG. 49.

FIG. 51 is a flow diagram illustrating an example implementation of the “determine a highest ranked metric association rule” procedure performed in FIG. 49.

### DETAILED DESCRIPTION

This disclosure presents computational methods and systems for managing and troubleshooting services in distributed computing system. In a first subsection, computer hardware, complex computational systems, and virtualization are described. Processes and systems for managing and troubleshooting services in a distributed computing system are described in a second subsection.

### Computer Hardware, Complex Computational Systems, and Virtualization

The term “abstraction” does not mean or suggest an abstract idea or concept. Computational abstractions are tangible, physical interfaces that are implemented using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. Software is a sequence of encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices. Multi-cloud aggregations, cloud-computing services, virtual-machine containers and virtual machines, containers, communications interfaces, and many of the other topics discussed below are tangible, physical components of physical, electro-optical-mechanical computer systems.

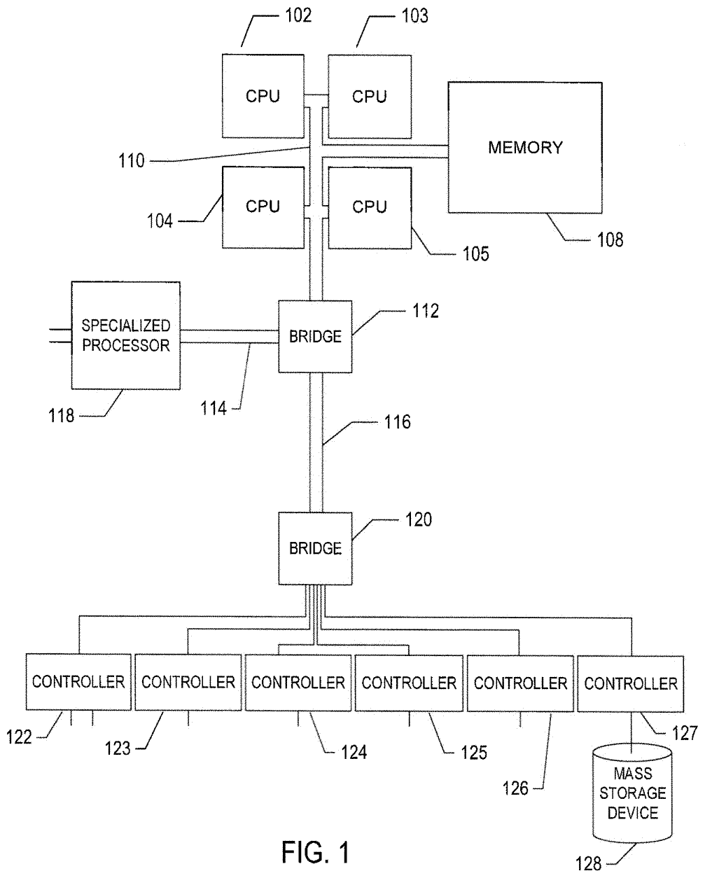

FIG. 1 shows a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

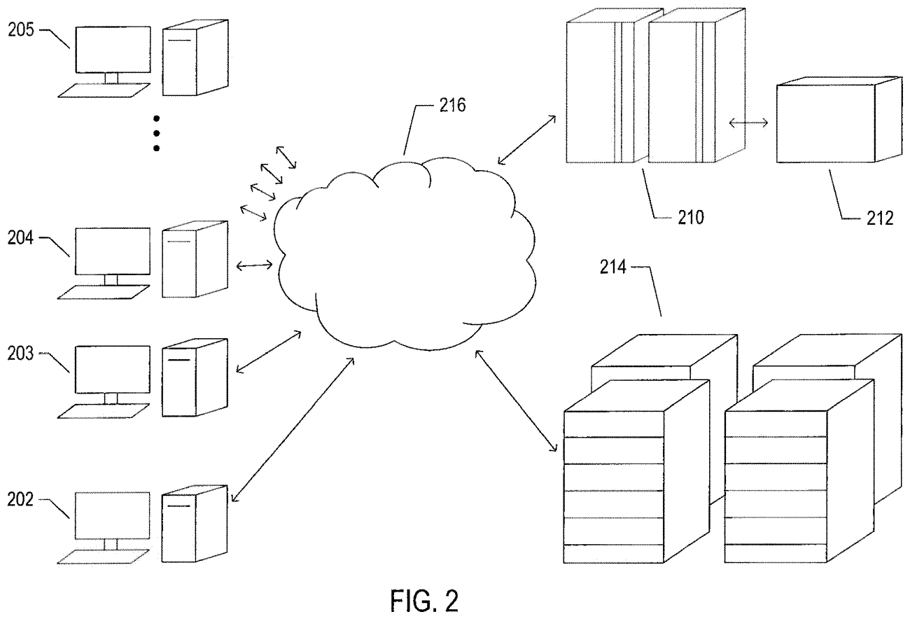

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

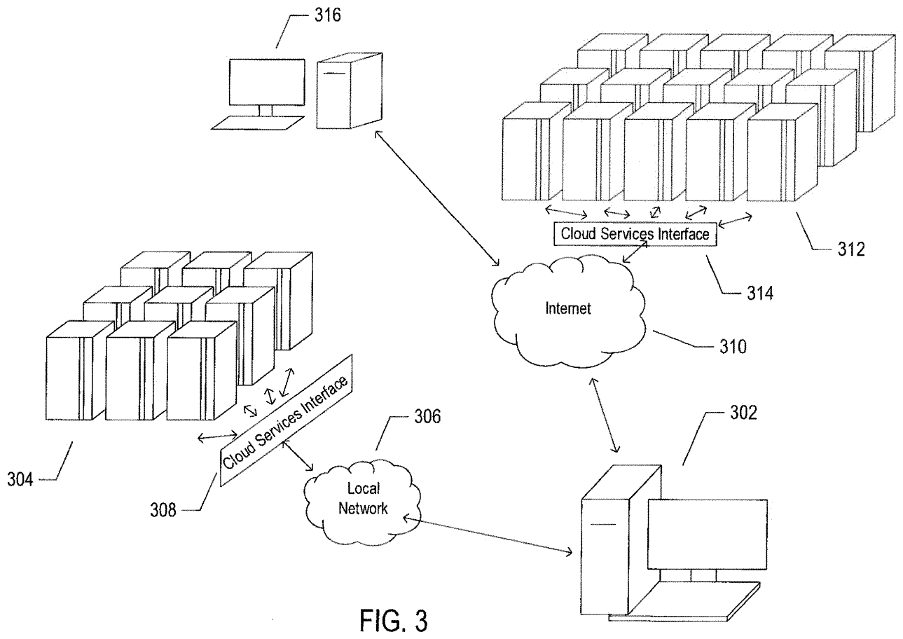

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

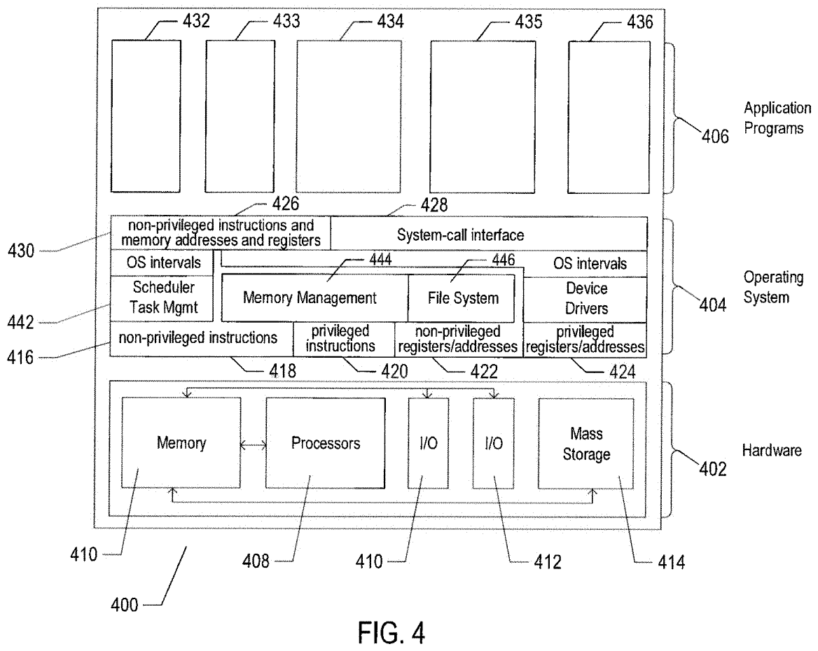

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

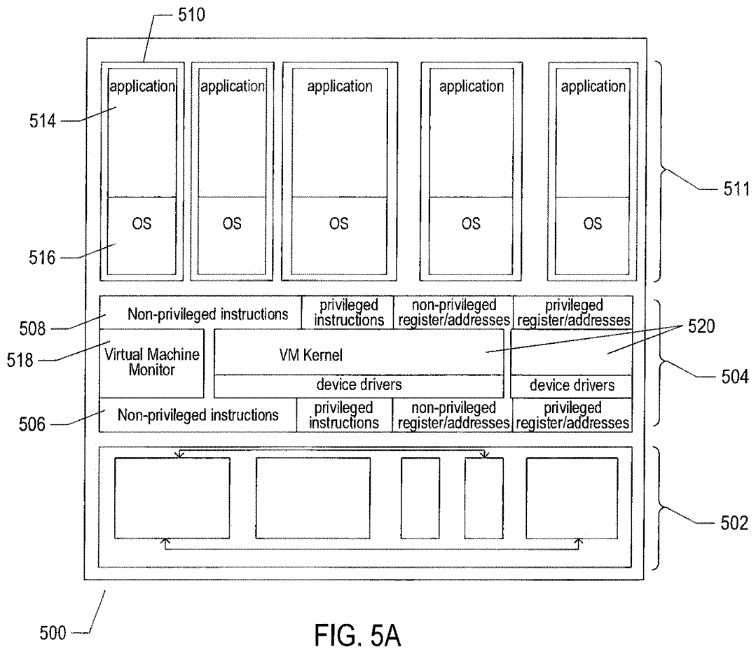

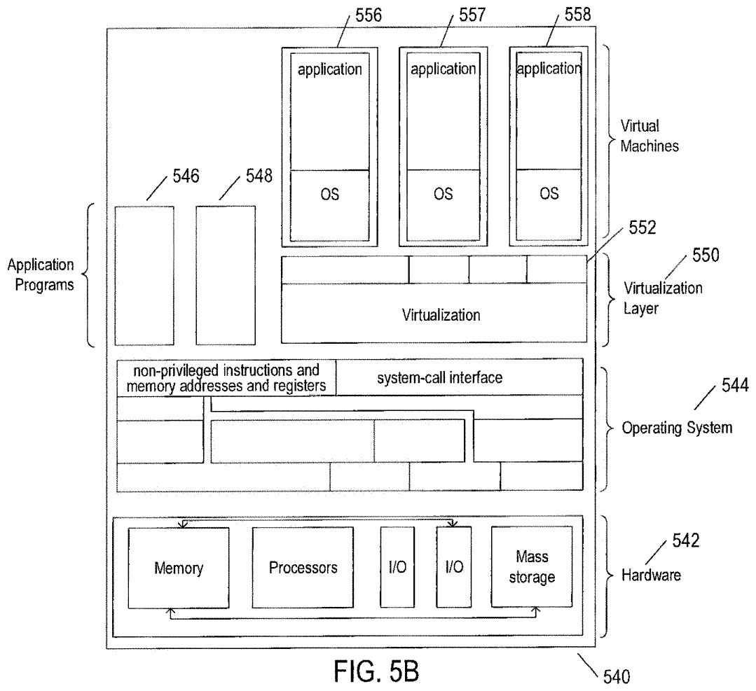

For the above reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtual layer 504 that interfaces through a virtualization-layer/hardware-layer interface 506, equivalent to interface 416 in FIG. 4, to the hardware. The virtual layer 504 provides a hardware-like interface to many VMs, such as VM 510, in a virtual-machine layer 511 executing above the virtual layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtual layer interface 504 rather than to the actual hardware interface 506. The virtual layer 504 partitions hardware devices into abstract virtual-hardware layers to which each guest operating system within a VM interfaces. The guest operating systems within the VMs, in general, are unaware of the virtual layer and operate as if they were directly accessing a true hardware interface. The virtual layer 504 ensures that each of the VMs currently executing within the virtual environment receive a fair allocation of underlying hardware devices and that all VMs receive sufficient devices to progress in execution. The virtual layer 504 may differ for different guest operating systems. For example, the virtual layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtual layer 504 includes a virtual-machine-monitor module 518 (“VMM”) also called a “hypervisor,” that virtualizes physical processors in the hardware layer to create virtual processors on which each of the VMs executes. For execution efficiency, the virtual layer attempts to allow VMs to directly execute non-privileged instructions and to directly access non-privileged registers and memory. However, when the guest operating system within a VM accesses virtual privileged instructions, virtual privileged registers, and virtual privileged memory through the virtual layer 504, the accesses result in execution of virtualization-layer code to simulate or emulate the privileged devices. The virtual layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtual layer 504 essentially schedules execution of VMs much like an operating system schedules execution of application programs, so that the VMs each execute within a complete and fully functional virtual hardware layer.

Figure SB shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtual layer 550 is also provided, in computer 540, but, unlike the virtual layer 504 discussed with reference to FIG. 5A, virtual layer 550 is layered above the operating system 544, referred to as the “host OS,” and uses the operating system interface to access operating-system-provided functionality as well as the hardware. The virtual layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtual layer 550 may reside within the host-operating-system kernel, such as a specialized driver incorporated into the host operating system to facilitate hardware access by the virtual layer.

It should be noted that virtual hardware layers, virtual layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtual layers, and guest operating systems are abstract or intangible. Virtual hardware layers, virtual layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

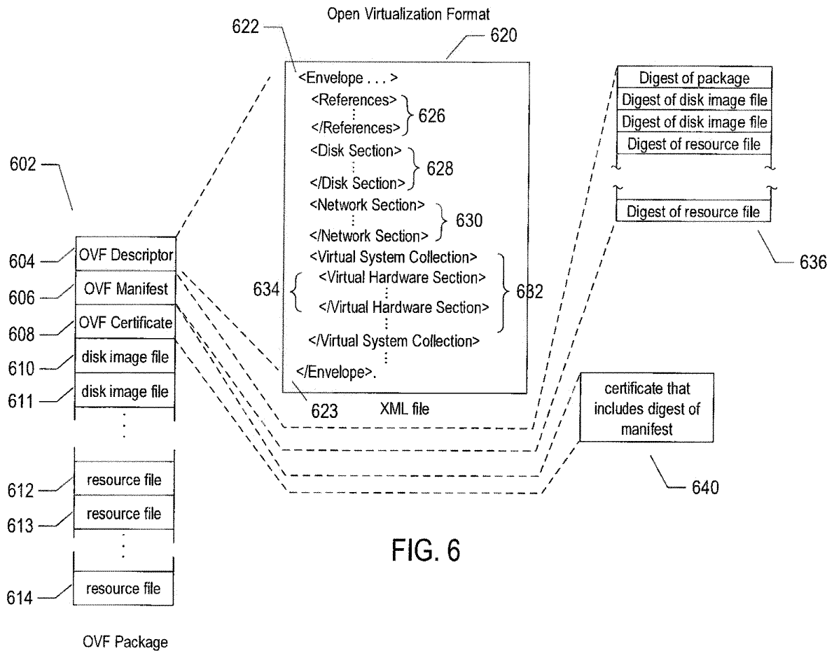

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtual layers running on many different types of computer hardware. A next level of abstraction, referred to as virtual data centers or virtual infrastructure, provide a data-center interface to virtual data centers computationally constructed within physical data centers.

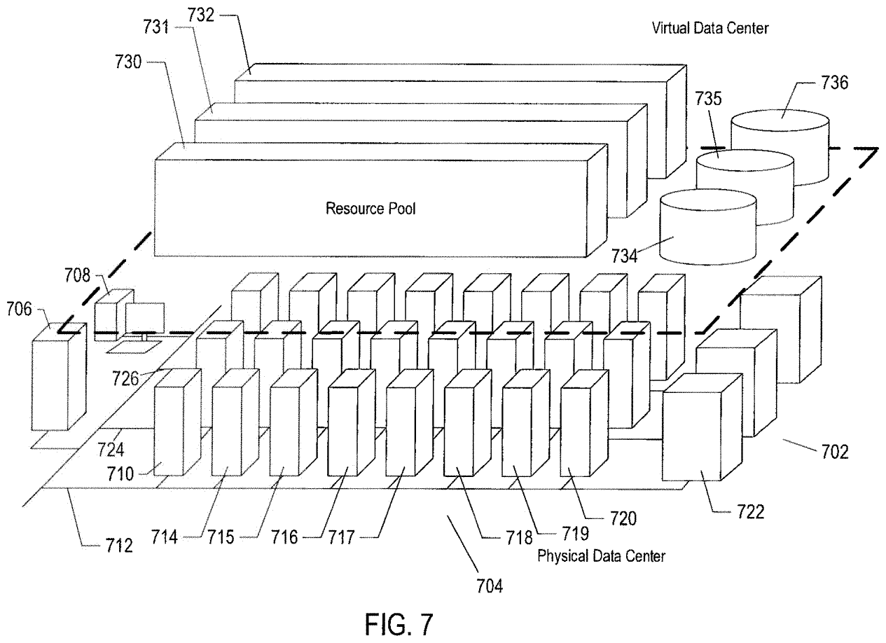

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtual layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

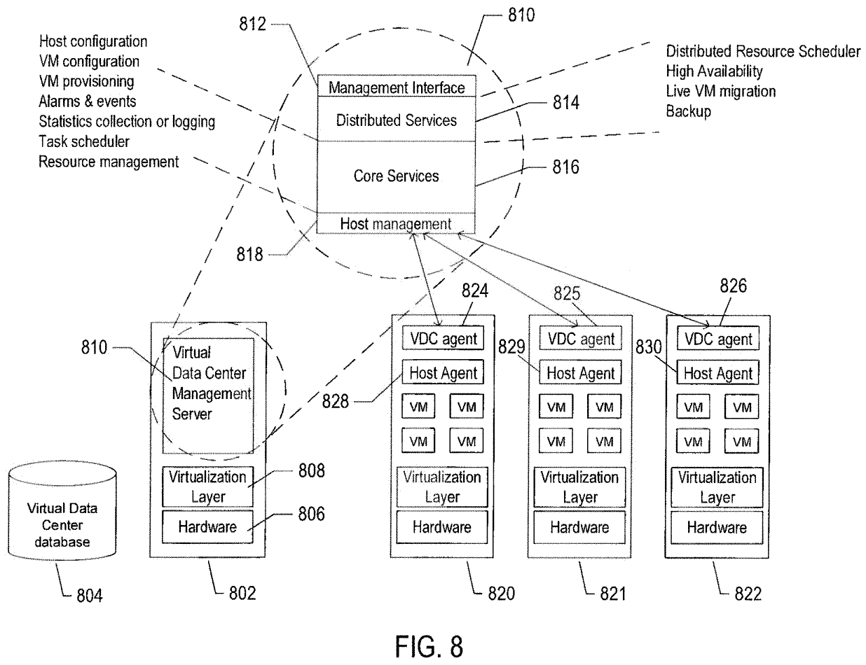

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtual layer 808, and runs a virtual-data-center management-server VM 810 above the virtual layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtual layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

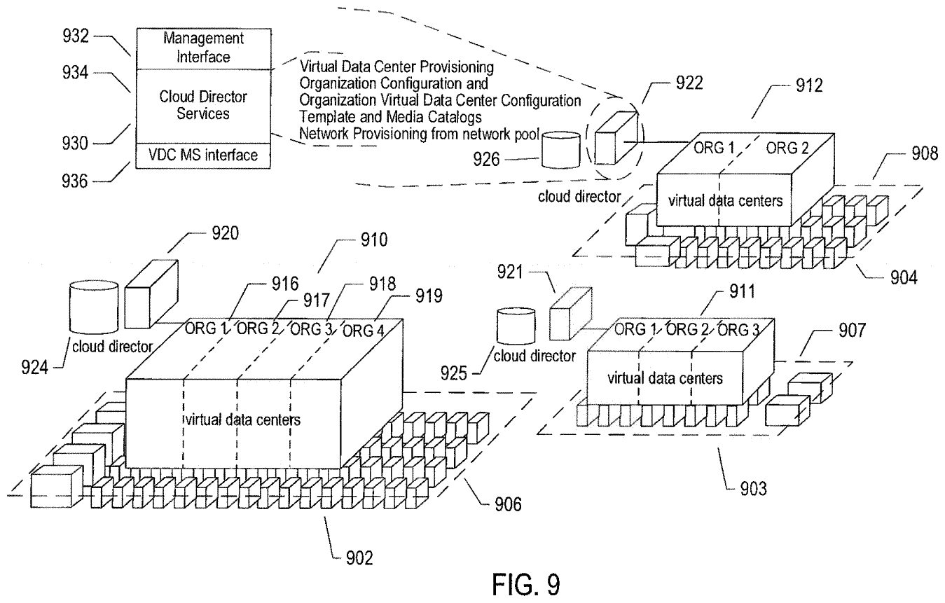

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

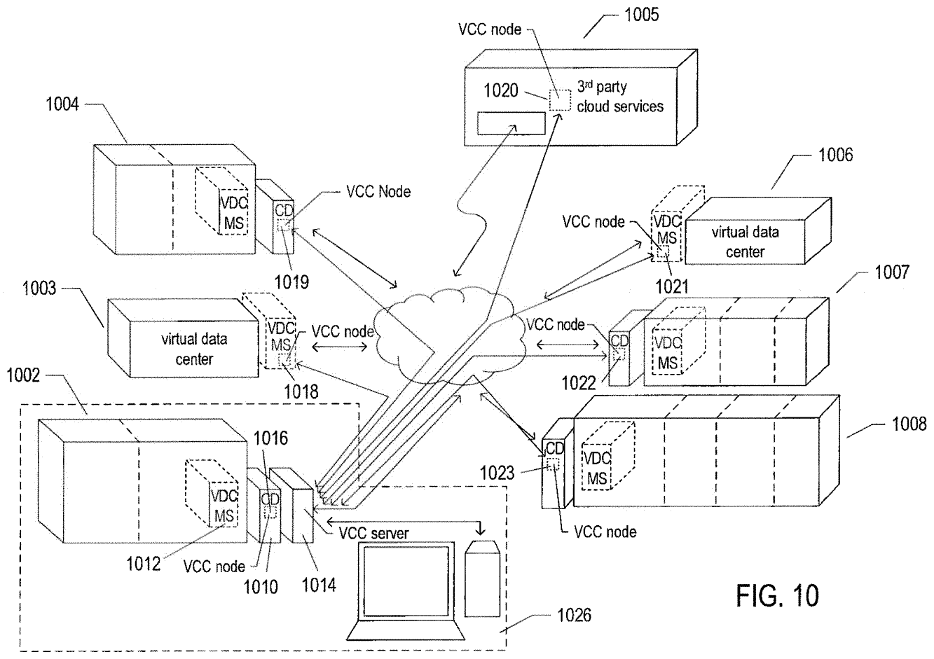

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtual layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtual layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files not included the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtual layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

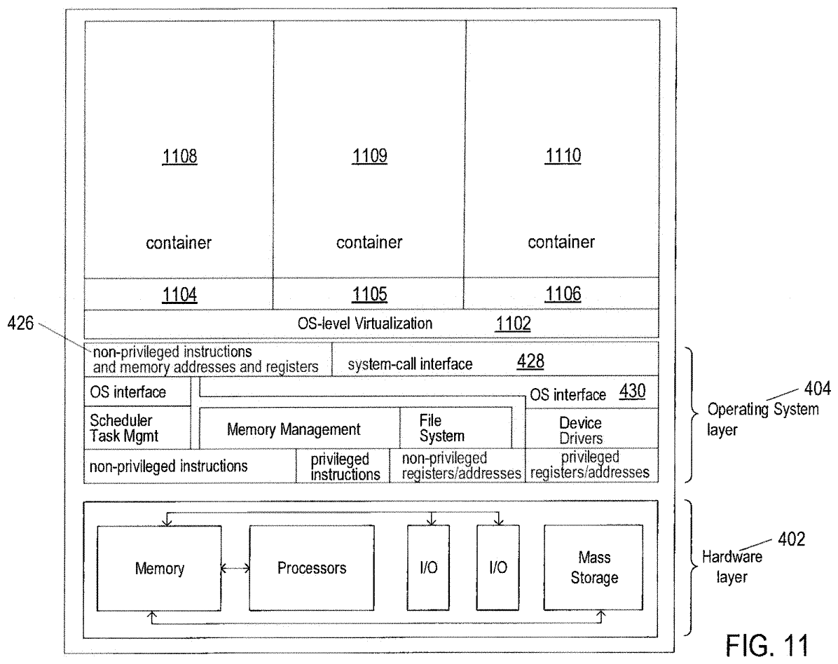

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtual layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

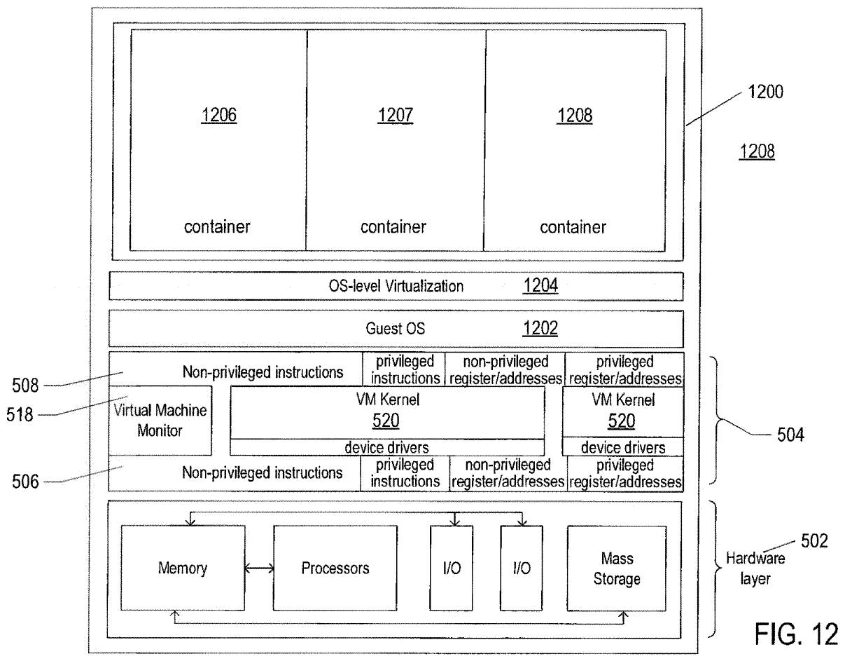

FIG. 12 shows an approach to implementing the containers on a VM. FIG. 12 shows a host computer similar to that shown in FIG. 5A, discussed above. The host computer includes a hardware layer 502 and a virtual layer 504 that provides a virtual hardware interface 508 to a guest operating system 1102. Unlike in FIG. 5A, the guest operating system interfaces to an OSL-virtual layer 1104 that provides container execution environments 1206-1208 to multiple application programs.

Note that, although only a single guest operating system and OSL virtual layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtual layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted to provide additional execution environments and associated resources for additional application instances. The resources available to the guest operating system are efficiently partitioned among the containers provided by the OSL-virtual layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtual layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtual layer and the advantages of OSL virtualization.

### Processes and Systems for Managing and Troubleshooting Services in a Distributed Computing System

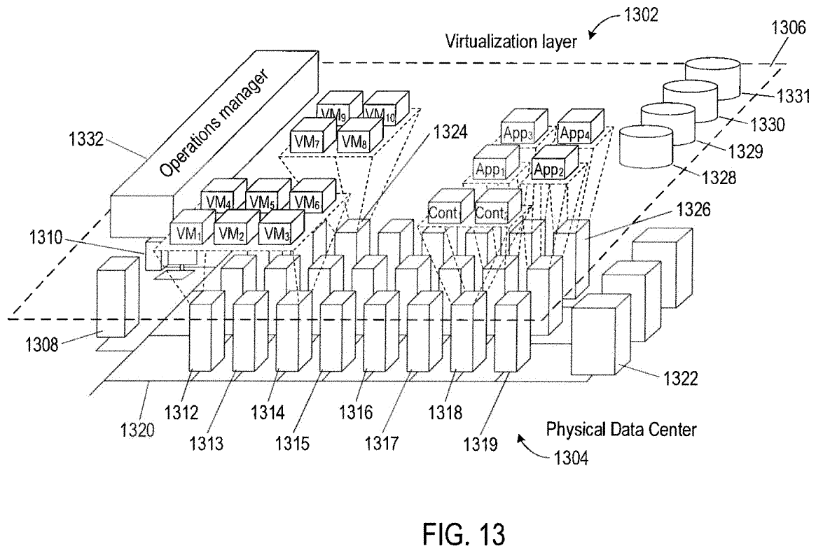

Computer-implemented processes and systems described herein are directed to automated management and troubleshooting of services provided by a distributed application executed in a distributed computing system. FIG. 13 shows an example of a distributed computing system comprising a virtualization layer 1302 and a physical data center 1304. For the sake of illustration, the virtualization layer 1302 is shown separated from the physical data center 1304 by a virtual-interface plane 1306. The physical data center 1304 is an example of a distributed computing system. The physical data center 1304 comprises physical objects, including an administration computer system 1308, any of various computers, such as PC 1310, on which a virtual data center (“VDC”) management interface may be displayed to system administrators and other users, server computers, such as server computers 1312-1319, data-storage devices, and network devices. Each server computer may have multiple network interface cards (“NICs”) to provide high bandwidth and networking to other server computers and data storage devices. The server computers are networked together to form server-computer groups within the data center 1304. The example physical data center 1304 includes three server-computer groups each of which have eight server computers. For example, server-computer group 1320 comprises interconnected server computers 1312-1319 that are connected to a mass-storage array 1322. Within each server-computer group, certain server computers are grouped together to form a cluster that provides an aggregate set of resources (i.e., resource pool) to objects in the virtualization layer 1302. Different physical data centers may include many different types of computers, networks, data-storage systems, and devices connected according to many different types of connection topologies.

The virtual-interface plane 1306 abstracts the resources of the physical data center 1304 to one or more VDCs comprising the virtual objects and one or more virtual data stores, such as virtual data stores 1328-1331. The virtualization layer 1302 includes virtual objects, such as VMs, applications, and containers, hosted by the server computers in the physical data center 1304. For example, one VDC may comprise the VMs running on server computer 1324 and virtual data store 1328. The virtualization layer 1302 may also include a virtual network (not illustrated) of virtual switches, virtual routers, virtual load balancers, and virtual NICs that utilize the physical switches, routers, and NICs of the physical data center 1304. Certain server computers host VMs and containers as described above. For example, server computer 1318 hosts two containers identified as Cont₁ and Cont₂; cluster of server computers 1312-1314 host six VMs identified as VM₁, VM₂, VM₃, VM₄, VM₅, and VM₆; server computer 1324 hosts four VMs identified as VM₇, VM₈, VM₉. VM₁₀. Other server computers may host single applications as described above with reference to FIG. 4. For example, server computer 1326 hosts an application identified as App₄.

Computer-implemented methods and systems for creating, discovering, and managing services described herein are performed by an operations manager 1332 in one or more VMs on the administration computer system 1308. The operations manager 1332 provides several interfaces, such as graphical user interfaces, that enable data center managers, system administrators, and application owners to automatically execute the processes and systems described below. The operations manager 1332 receives and collects object information from objects of the data center. In the following discussion, the term “object” refers to a physical object or a virtual object. A physical object can be a server computer, a network device, a workstation, or a PC of a distributed computed system. A virtual object may be an application, a VM, a virtual network device, a container, a data store, or a software component of a distributed application. The term “resource” refers to a physical resource of a distributed computing system, such as, but are not limited to, a processor, a processor core, memory, a network connection, network interface, data-storage device, a mass-storage device, a switch, a router, and other any other component of the physical data center 1304. Resources of a server computer and clusters of server computers may form a resource pool for running virtual resources of a virtual infrastructure comprising virtual objects. The term “resource” may also refer to a virtual resource, which may have been formed from physical resources used by virtual objects. For example, a resource may be a virtual processor formed from one or more cores of a multicore processor, virtual memory formed from a portion of physical memory, virtual storage formed from a sector or image of a hard disk drive, a virtual switch, and a virtual router.

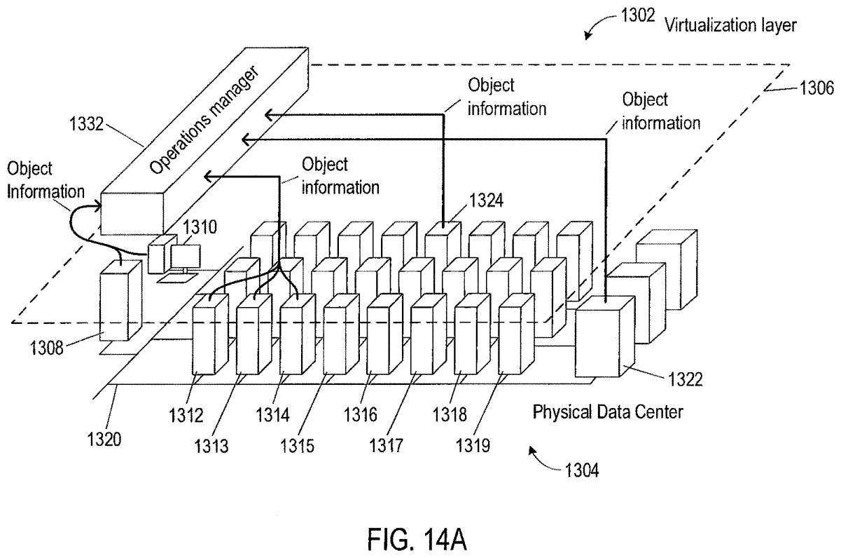

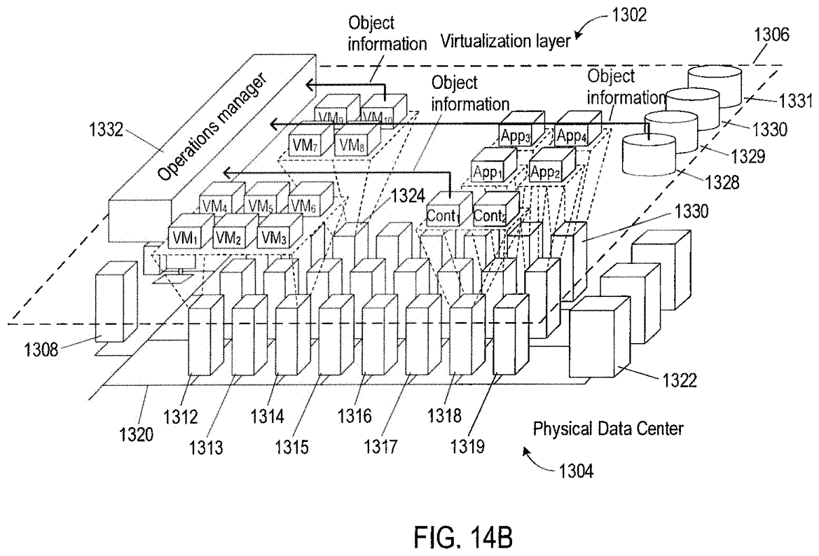

FIGS. 14A-14B show examples of the operations manager 1332 receiving object information from various physical and virtual objects. Directional arrows represent object information sent from physical and virtual resources to the operations manager 1332. The object information descried below includes attributes, metrics, events, and properties of virtual and physical objects. In FIG. 14A, the operating systems of PC 1310, server computers 1308 and 1324, and mass-storage array 1322 send object information to the operations manager 1332. A cluster of server computers 1312-1314 send object information to the operations manager 1332. In FIG. 14B, the VMs, containers, applications, and virtual storage may independently send object information to the operations manager 1332. Certain objects send information as the information is generated while other objects may only send information at certain times or when requested to send information by the operations manager 1332.

Enterprises, governments, and other organizations conduct commerce, provide services over the Internet, and process large volumes of data using distributed applications executed in data centers. A distributed application comprises multiple software components that are executed on one or more server computers. Each software component communicates and coordinates actions with other software components and data stores to appear as a single coherent application that provides services to an end user. Software components are executed separately in VMs and/or containers. For example, the VMs VMᵢ, i=1, . . . , 10, in FIG. 13 are an example of different software components of an example distributed application used to describe methods and systems for creating, discovering, and managing a distributed computing system. Distributed applications are typically executed and developed in different tiers of a multitier architecture created by developers of a distributed application. In the following discussion. VMs VMᵢ, i=1, . . . , 10, are described as being software components of a three-tier architecture in which application components are organized into three logical and physical computing tiers: a user-interface (“UI”) tier or presentation tier; a logic tier where data is processed; and a data tier where the data associated with the application is stored, persisted, and managed. Note that processes and systems describe below are not limited to a three-tier architecture and may be used with a two-tier architecture or an architecture having more than three tiers. A primary advantage of a multitier architecture is that because each tier runs on its own infrastructure, each tier is developed simultaneously by a separate software engineering team and can be updated or scaled as needed without impacting the other tiers.

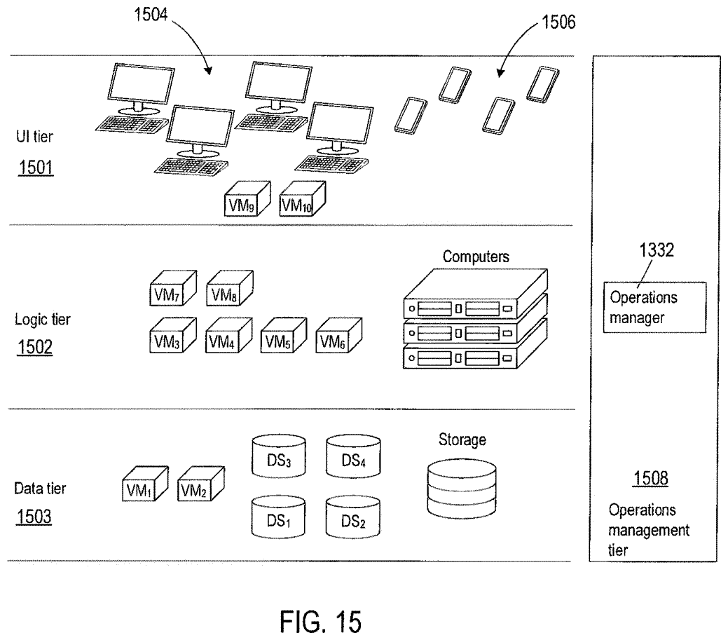

FIG. 15 shows an example of three tiers identified as a UI tier 1501, a logic tier 1502, and a data tier 1503. The UI tier 1501 is a communications layer that enables a user to interact with the distributed application. In this example, the UI tier 1501 is executed with VMs VM₉ and VM₁₀ that translate information input by users at UIs, such as browsers and graphical user interfaces (“GUIs”) running on desktop computers 1504 or mobile apps running on mobile devices 1506, into information that is sent to the logic tier 1502. The VMs VM₉ and VM₁₀ translate information generated by the logic tier 1502 into information that can be displayed in the browsers and (“GUIs”) running on the desktop computers 1504 and in the mobile apps running on the mobile devises 1506. In the logic tier 1502, information collected and displayed in the UI tier 1501 is processed by the VMs VM₃, VM₄, VM₅, VM₆, VM₇, and VM₈ in workflows that generate data that is stored in the data tier 1503 and delete or modify data stored in the data tier 1503. In the data tier 1503, the VMs VM₁ and VM₂ store, persist, and manage data stored in data stores DS₁, DS₂, DS₃, and DS₄ that are, in turn, stored on physical data storage devices and appliances. For example, VMs VM₁ and VM₂ can be a relational database management system that provides access to data stored in the datastores DS₁, DS₂, DS₃, and DS₄. The operations manager 1332 is executed in a separate operations management tier 1508 that provides real-time monitoring of the virtual and physical infrastructure and compute workloads of the objects in the UI tier 1501, the logic tier 1502, and the data tier 1503 based on the object information provided by objects in these tiers.

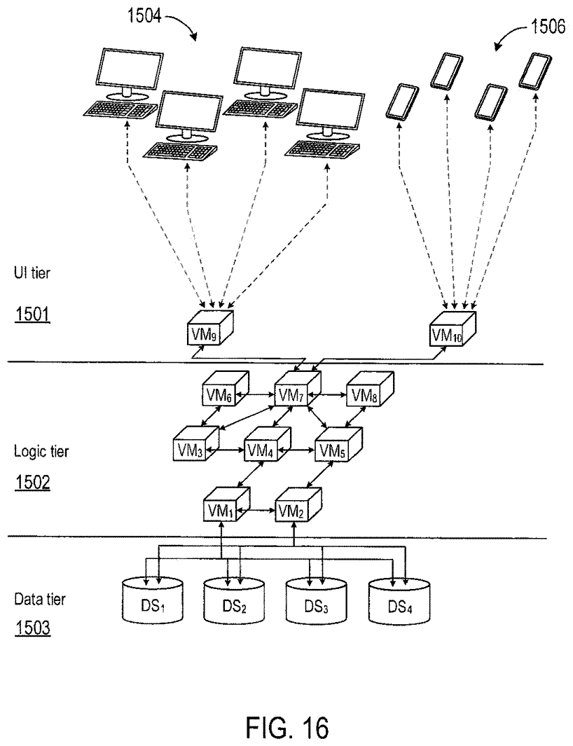

In a three-tier distributed application, the UI tier 1501 and the data tier 1503 cannot communicate directly with one another. Communications between the UI tier 1501 and the data tier 1503 passes through and is processed objects in the logic tier 1502. FIG. 16 shows an example architecture of the ten VMs VMᵢ, i=1, . . . , 10, in the different tiers 1501-1503 of FIG. 15 exchange data as represented by directional arrows. The architecture is an example of interactions between software components of a distributed application of an ecommerce business that provides a service. VMs VM₉ and VM₁₀ display websites of the business in the browsers and GUIs of the desktop computers 1504 and mobile devices 1506, translate information, such as user addresses, orders, and banking, into data that is sent to VM₇. VM₇ distributes the data provided by the users to the other VMs VM₃, VM₄, VM₅, VM₆, and VM₈, which perform specific and business operations, such as check and update inventory in a warehouse, perform transactions with uses' banks, update users' records, arrange for carriers to transport selected goods to the users, order merchandise from vendors, and perform accounting for the business. The VMs in the logic tier 1502 use VMs VM₁ and VM₂ in the data tier 1503 to access user data, warehouse inventory, and accounting information stored in the datastores DS₁, DS₂, DS₃, and DS₄ and update data in the datastores DS₁, DS₂, DS₃, and DS₄ in response to instructions from the logic tier 1502. When transactions are completed, VMs VM₉ and VM₁₀ send information directly to the corresponding user interfaces of the desktop computers 1504 and mobile devices 1506.

The operations manager actively queries, discovers, and identifies candidate objects, such as hosts, VMs, and containers, for enrollment into the service of the distributed application using object metadata or increased interaction, such as increased netflows, with objects that are already unenrolled in the service. The operations manager automatically adjusts the service of the distributed application is to include the discovered and enrolled objects. In one implementation, the operations manager queries and discovers objects based on metadata of the objects and presents a recommendation to a user in a GUI for adding the discovered object to the structure of the distributed application.

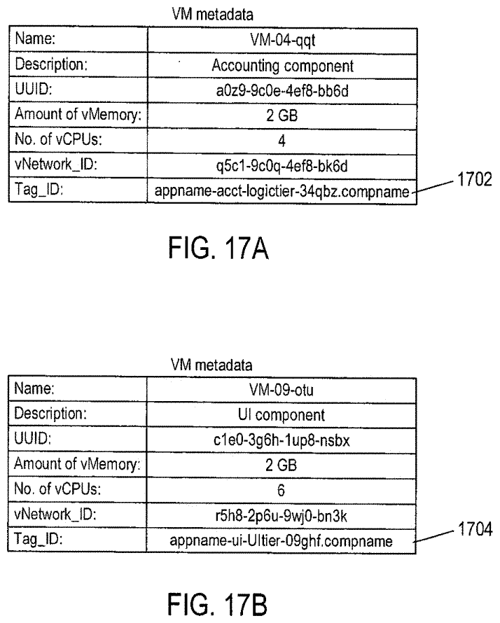

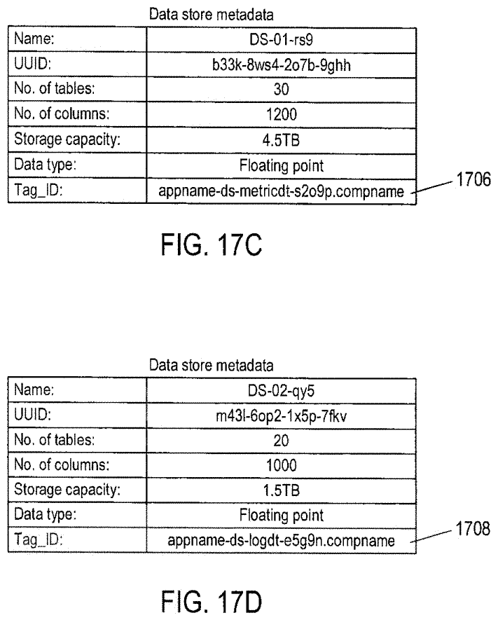

FIGS. 17A-17B show examples of metadata for example VMs VM₄ and VM₉, respectively. The metadata associated with the VMs are represented by tables that are stored in a data-storage device. The metadata contains the VM name, description, UUID, amount of virtual memory allocated to the VM, number of virtual CPUs allocated the VM, virtual network identifier (“ID”), and a tag_ID. In this example, the tag_IDs are structured to identify the name of a distributed application, type of operation performed by the corresponding VM, the tier the VM belongs to, a unique tag_ID, and a component name. In the example of FIG. 17A, tag_ID 1702 of VM₄ identifies the name of the application, describes the VM₄ as running an accounting component identified as “acct” and indicates VM₄ is in the logic tier 1502. In the example of FIG. 17B, tag_ID 1704 of VM₉ identifies the name of application, describes the VM₉ as running a UI component identified as “ui” and indicates VM₉ is in the UI tier 1501.

FIGS. 17C-17D show examples of metadata for example datastores DS₁ and DS₂, respectively. The metadata associated with the VMs are represented by tables that are stored in a data-storage device. The metadata contains the datastore name, UUID, number of tables, number of columns in each table, storage capacity of the datastore, data type, and a tag_ID. In the example of FIG. 17C, tag_ID 1706 of DS₁ identifies the name of application, identifies the object as a datastore with “ds,” identifies the type of data in the datastore as metric data “metricdt” data. In the example of FIG. 17D, tag_ID 1708 of DS₂ identifies the name of application, identifies the object as a datastore with “ds.” identifies the type of data in the datastore as log message data “log dt” data. Similar metadata is maintained in data storage for other objects such as hosts and containers.

The operations manager uses the information in the tag_IDs to discover objects and recommend adding the objects to the service of a distributed application. For example, a software engineering team may have created an object, such as a software component or datastore, that is used by objects of the distributed application and created a tag_ID for the object that includes information that overlaps information in the tag_IDs of objects of the distributed application. The operations manager queries each object that is used by the distributed application and not considered an object of the distributed application and determines whether tag_ID of the object overlaps (i.e., contains common words or terms) the tag_IDs of other objects of the distributed application. If the tag-IDs overlap, the operations manager generates a recommendation to add the discovered object to the service of the distributed application.

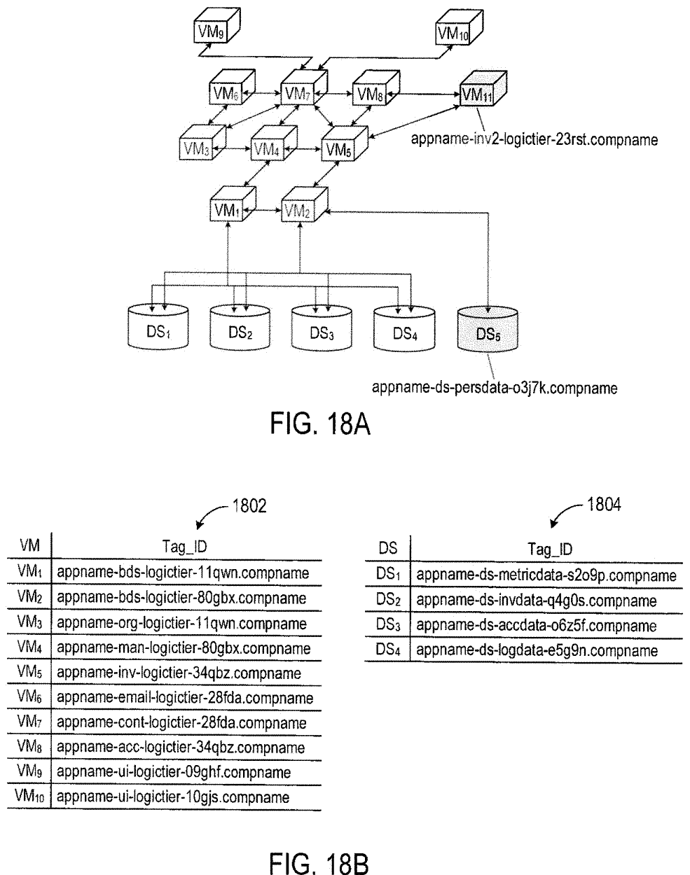

FIG. 18A shows the example architecture of the ten VMs VMᵢ, i=1, . . . , 10, and four datastores DSⱼ, j=1, 2, 3, 4, described above with reference to FIG. 16. FIG. 18B shows a table of VM tag_IDs 1802 and a table of datastore tag_IDs 1804. Each of the tag_IDs in table 1802 identifies the same application name “appname” and identifier that identifies the function performed by the VM, such “bds” for database, org for organization, “man” for application manager, “inv” for inventory. “email” to handle emails, and “cont” for controller. Each of the tag_IDs in table 1804 identifies the name of the application “appname” and an identifier that identifies the kind of data stored in the respective datastore, such “invdata” for inventory data. “accdata” for accounting data, and “logdata” for log message generated by the software components and hardware used to execute the distributed application. In FIG. 18A, software engineers have created a VM, VM₁₁, that provides additional management of inventory and has a tag_ID “appname-inv2-logictier-23rst.compname” and created a datastore, DS₅, for storing personnel information of business employees with a tag_ID “appname-ds-persdata-o3j7k.compname.” In particular, the operations manager matches “appname” of the tag_IDs of VM₁₁ and DS₅ to “appname” of the tag_IDs of the other VMs and datastores of the distributed application and recommends VM₁₁ and datastore DS₅ for addition to the service provided by the distributed application in a graphical user interface.

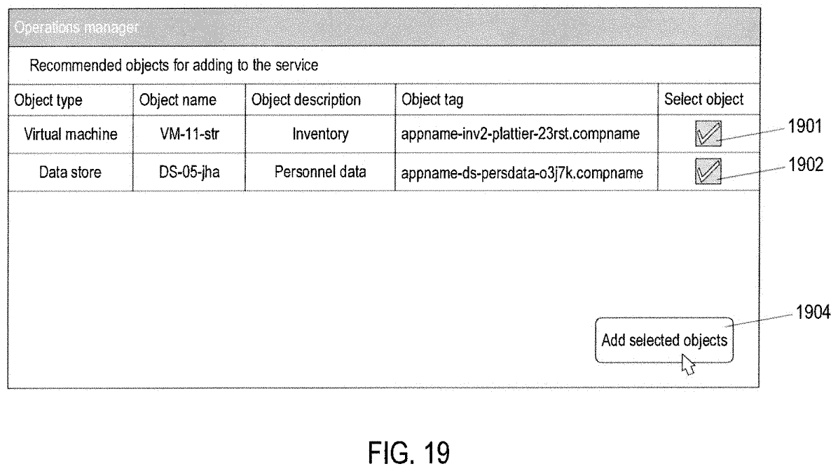

FIG. 19 shows an example GUI that presents VM₁₁ and DS₅ as recommended objects to add to the service of the distributed application. In this example, the GUI shows object type, object name, object description, and object tag_IDs. The user accepted the recommendations by clicking on boxes 1901 and 1902 and adds the objects to the service of the distributed application by clicking on button 1904.

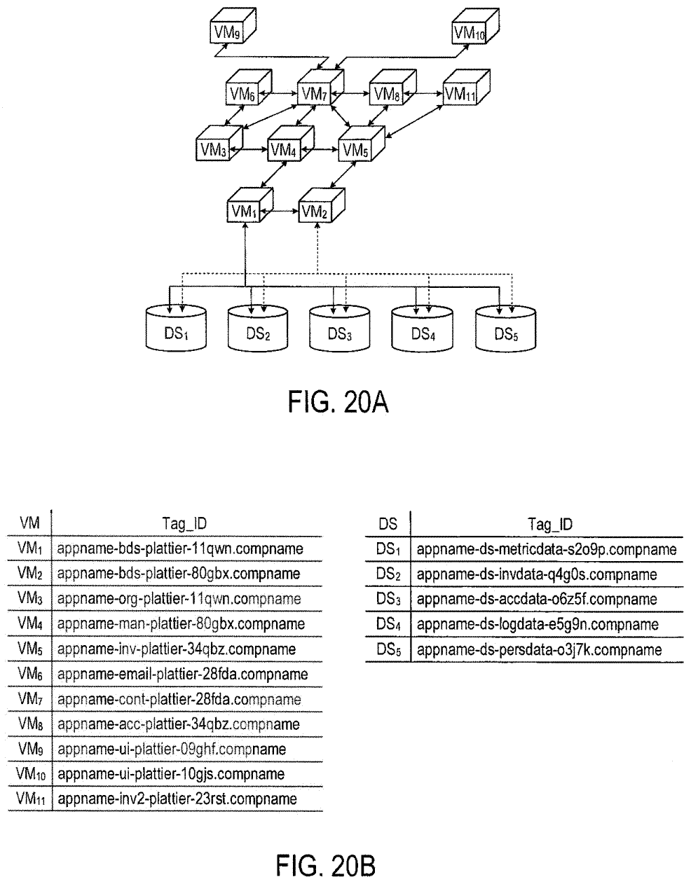

FIG. 20A shows the example VM₁₁ and DS₅ enrolled in the service provided by the distributed application. The architecture of the distributed application contains eleven VMs VMᵢ, i=1, . . . , 11, and five datastores DSⱼ, j=1, . . . , 5. FIG. 20B shows a table of VM tag_IDs 2002 with the tag-ID of VM₁₁ added and a table of datastore tag_IDs 2004 with a tag_ID of DS₅ added.

In another implementation, the operations manager discovers objects based on intensities of netflows between objects of the structure of the distributed application and outside objects that have not been added to the structure of the distributed application. NetFlow data is analyzed to determine network traffic flow and volume, such as total number of packets sent and received by an outside object communicating with an object of the distributed application. When the netflow between an outside object and objects of the distributed application exceeds a threshold for a period of time, the operations manager generates a recommendation in GUI to add the object to the service of the distributed application. For example, the period of time may be a user-selected period of time, such as 30 seconds, one minute, five minutes, or ten minutes.

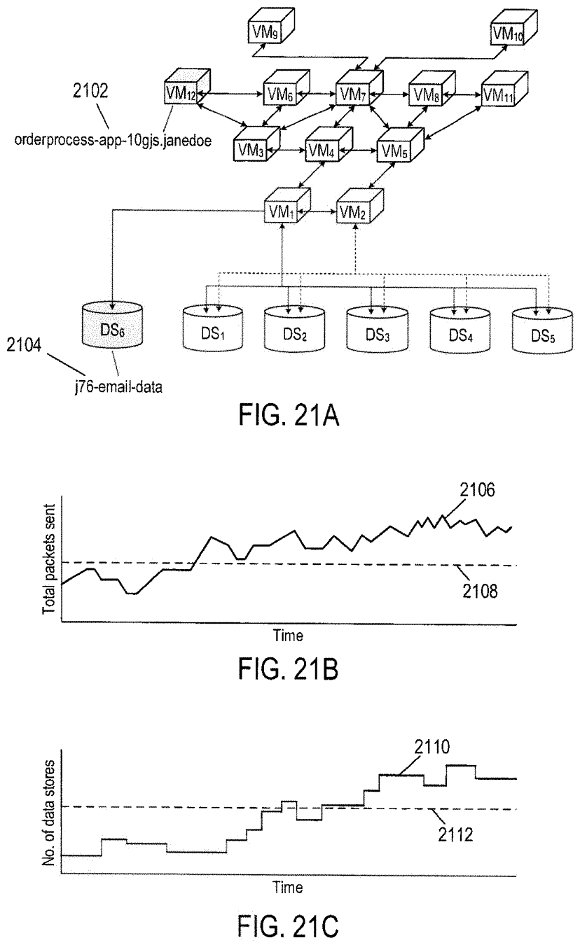

FIG. 21A shows the example architecture of the eleven VMs VMᵢ, i=1, . . . , 11, and five datastores DSⱼ, j=1, . . . , 5, described above with reference to FIG. 20A. In this example, VM₁₂ sends data to and receives data from VMs VM₃ and VM₆ and DS₆ receives data from VM₁. VM₁₂ has a tag_ID 2102 and DS₆ has a tag_ID 2104, which do not identify the name of the distributed application. FIG. 21B shows an example plot of the total number of packets sent to and from VM₁₂ over time. Curve 2106 represents the total number of packets at points in time. Dashed line 2108 represents a threshold for recommending a VM to be added to the service of the distributed application. In this example, the total number of packets exchanged between VM₁₂ and VMs VM₃ and VM₆ exceeds to the threshold 2108 for a period of time. As a result, VM₁₂ is a candidate for addition to the structure of the distributed application. FIG. 21C shows an example plot of datastores by VM₁ and DS₆ over time. Curve 2110 represents the number of datastores at points in time. Dashed line 2108 represents a threshold for recommending DS₆ to be added to the service of the distributed application. In this example, the number of datastores exceeds the threshold 2112 for a period of time. As a result, DS₆ is a candidate for addition to the structure of the distributed application. Note that the duration of the period of times associated with exceeding the thresholds 2108 and 2111 is a user-selected threshold.

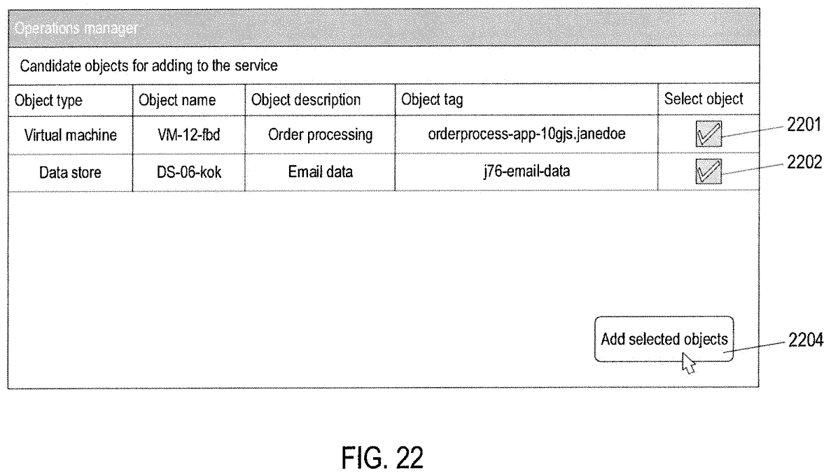

FIG. 22 shows an example GUI that presents VM₁₂ and DS₆ as recommended objects to add to the service of the distributed application. In this example, the GUI shows object type, object name, object description, and object tag_IDs. The user accepted the recommendations by clicking on boxes 2201 and 2202 and adds the objects to the service of the distributed application by clicking on button 2204.

FIG. 23A shows the example VM₁₂ and DS₆ enrolled in the service provide by the distributed application. The architecture of the distributed application contains twelve VMs VMᵢ, i=1, . . . , 12, and six datastores DSⱼ, j=1, . . . , 6. The tag_IDs 2102 and 2104 have been changed to tag_IDs 2302 and 2304, respectively, to include the application name and describe the objects. FIG. 23B shows a table of VM tag_IDs 2306 with the tag-ID of VM₁₂ added and a table of datastore tag_IDs 2308 with a tag_ID of DS₆ added.

The operations manager runs automated analytics on metrics generated by objects and service level metrics to detect abnormally behaving physical and virtual objects. A service level metric is a total anomaly, or outlier, count of metrics of a distributed application over time. Service level metrics include performance metrics that characterize the service in general. For example, a service level metric is an average, or maximum, response time of the service provided by the distributed application to a user request, or the average, or maximum, response time of each tier of the distributed application to requests from objects in the other tiers, or a service level metric is the number of active users of the distributed application over time. The operations manager also receives metrics related to costs and capacity associated with objects of the service provided by distributed application. For example, a total cost metric characterizes the cost of hosting resources over time, cost of consumed storage over time, and cost of operating hosts over time. For each of these metrics, the operations manager computes a dynamic threshold that is used to determine a baseline behavior and any behavior that exceeds a dynamic threshold is identified as an outlier that is reported to system administrators and software engineers. The operations manager computes dynamic thresholds and detects metric outliers as described in U.S. Pat. No. 10,241,887, issued Mar. 26, 2019, owned by VMware, Inc, and is herein incorporated by reference.

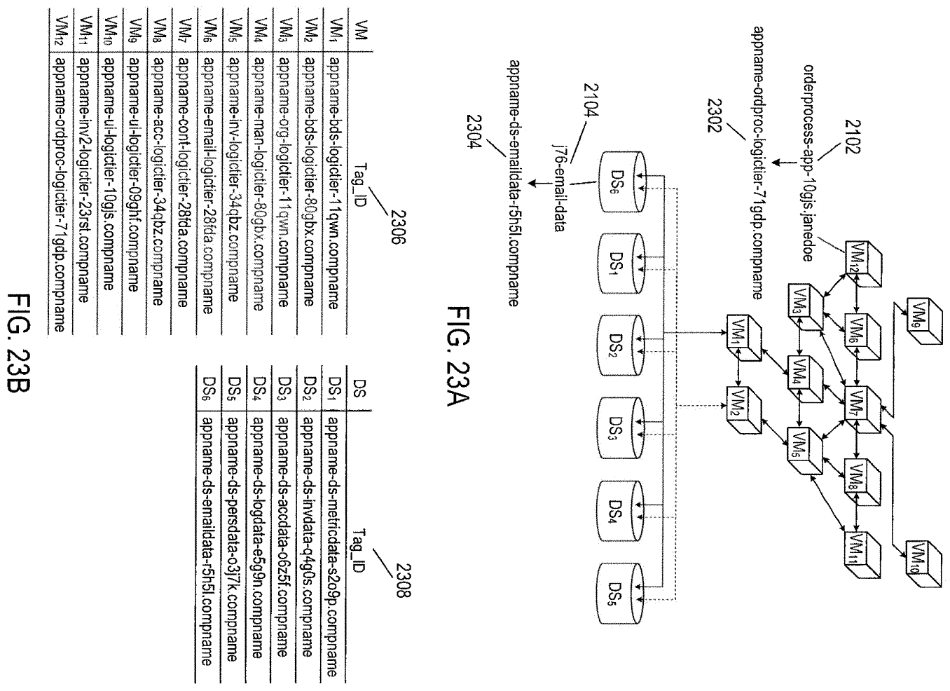

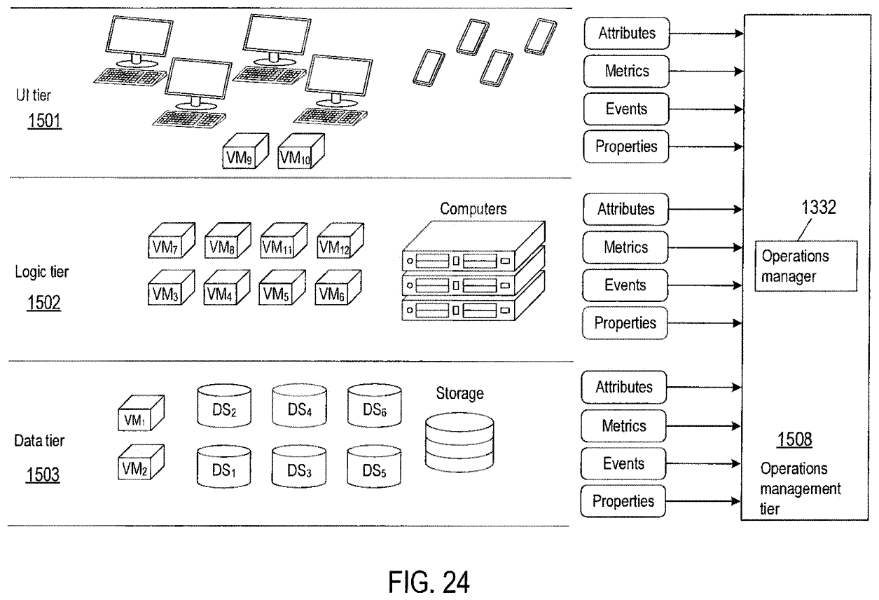

FIG. 24 shows an example of various types of object information sent to the operations manager 1332 from objects in the UI tier 1501, the logic tier 1502, and the data tier 1503. As shown in FIG. 24, the object information sent from each of the tiers includes attributes, metrics, events, and properties. A metric is a stream of time-dependent metric data that is generated by an operating system, a resource, or by an object, such as a VM or container. A stream of metric data associated with a resource comprises a sequence of time-ordered metric values that are recorded in spaced points in time called “time stamps.” A stream of metric data is simply called a “metric” and is denoted by

M=(xᵢ)ᵢ₌₁^{Q}=(x(tᵢ))ᵢ₌₁^{Q} (1)
where
   M denotes the metric:
   Q is the number of metric values in the sequence;
   xᵢ=x(tᵢ) is a metric value;
   tᵢ is a time stamp indicating when the metric value was recorded in a data-storage device; and
   subscript i is a time stamp index i=1, . . . , N.

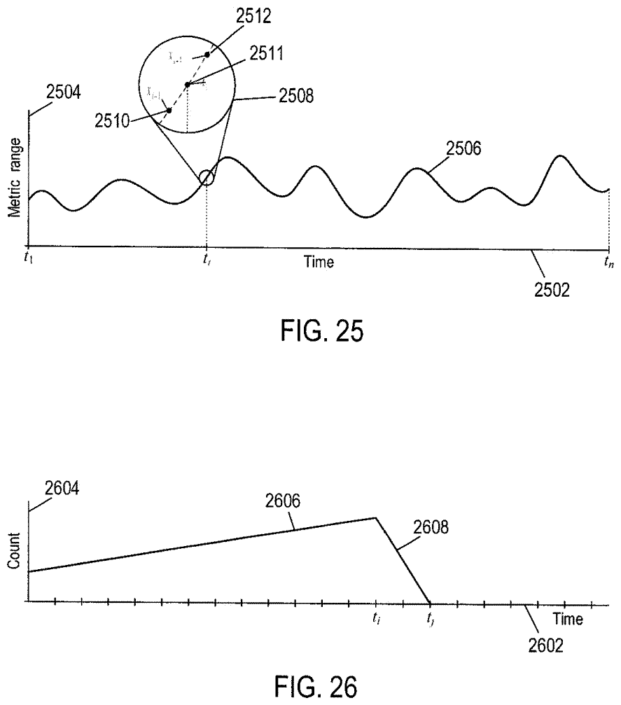

FIG. 25 shows a plot of an example metric. Horizontal axis 2502 represents time. Vertical axis 2504 represents a range of metric values or amplitudes. Curve 2506 represents a metric as time series data. In practice, a metric comprises a sequence of discrete metric values in which each metric value is recorded in a data-storage device. FIG. 25 includes a magnified view 2508 of three consecutive metric values represented by points. Each point represents an amplitude of the metric at a corresponding time stamp. For example, points 2510-2512 represent consecutive metric values (i.e., amplitudes) xᵢ₋₁, xᵢ, and xᵢ₊₁ recorded in a data-storage device at corresponding time stamps tᵢ₋₁, tᵢ, and tᵢ₊₁. The example metric may represent usage of a physical or virtual resource. For example, the metric may represent CPU usage of a core in a multicore processor of a server computer over time. The metric may represent the amount of virtual memory a VM uses over time. The metric may represent network throughput for a server computer or host. The metric may represent network traffic for a server computer or a VM. The metric may also represent object performance, such as CPU contention, response time to requests, latency, cost per unit time, electric power usage, and wait time for access to a resource of an object.

An event is any occurrence recorded in a metric that triggered an alert. Adverse events include faults, change events, and dynamic threshold violations resulting from metric values exceeding a dynamic threshold. An attribute is a property associate with an event, such as criticality of the event, including identity of the metric and username. IP address, and ID of the resource or object associated with the event. Properties are metrics that record property changes, such as a metric that counts processes running on an object at a point in time or the number of responses to client requests executed by an object or an application.

FIG. 26 show a plot of an example property metric. Horizontal axis 2602 represents time. Vertical axis 2604 represents a count of operations. Marks along the time axis 2602 represent points in time when a count of the number of operations executed by the object is recorded. Line 2606 represents the number of operations executed by the object up to time tᵢ. After time tᵢ the number of operations executed by the object decreases to zero at time tⱼ as represented by line 2608 and remains at zero.

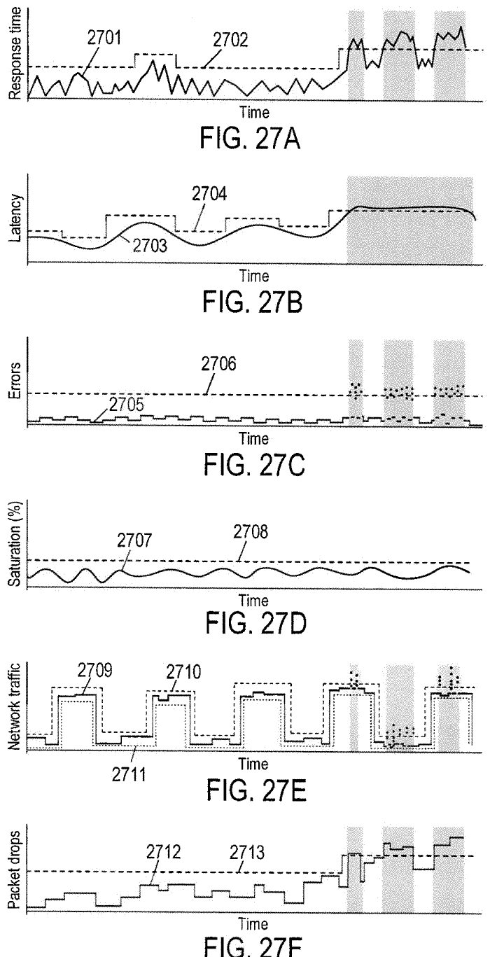

FIGS. 27A-27F show plots 2701-2706 of example metrics and associated dynamic thresholds. In FIG. 27A, curve 2701 represents response time and dashed curve 2702 represents a response time dynamic threshold. In FIG. 27B, curve 2703 represents latency and dashed curve 2704 represents a latency dynamic threshold. In FIG. 27C, curve 2705 represents errors produced by an object and dashed curve 2704 represents an errors dynamic threshold. In FIG. 27D, curve 2707 represents saturation and dashed curve 2704 represents a saturation dynamic threshold. Saturation is the percentage of resources used by an application or object per unit time. In FIG. 27E, periodic curve 2709 represents network traffic, upper dashed curve 2710 represents an upper dynamic threshold, and lower dotted curve 2711 represents a lower dynamic threshold. In FIG. 27F, curve 2712 represents packet drops and dashed curve 2713 represents a dynamic threshold. Shade regions in FIGS. 27A-27C and 27E-27F identify time intervals where the example metrics violate corresponding dynamic thresholds, which are indicators of abnormal behaviors the translate into application performance problems. In this example, the abnormal behaviors exhibited in FIGS. 27A-27C and 27E-27F may be related, or correlated, because the anomalies occur in overlapping time intervals. By contrast, the saturation metric does not exhibit any anomalous behavior in the same time intervals and does not appear to be correlated with the behavior represented in the other metrics.

Health status of a service provided by a distributed application is characterized by aggregated statuses of the tiers and the objects in the tiers. A critical alert triggered for one or more objects of one of three tiers might mean 66% health status for the service provided by the distributed application. A critical alert for a tier may be the result of a combination of one or more of adverse events recorded in the metrics of objects in the tier.

The operations manager constructs aggregated anomaly count metrics from metrics of objects of the distributed application generated during run time of the distributed application. The objects may be the full set of objects used to implement the service of the distributed application in a data center. The objects may be only the objects in a tier of the service of the distributed application. The objects may be a subset of the objects within a tier of the service of the distributed application.

Let Ω={M₁, M₂, . . . , M_{θ}} be a set of metrics associated with objects of the service of the distributed application, where θ is the number of metrics. For example, metric M₁ may represent physical or virtual CPU usage of an object, M₂ may represent memory usage of an object, and M_{θ} may represent response time of an object. The metrics are synchronized to the same set of time stamps and missing metrics are filled in using interpolation or a moving average. The set of metrics Ω may represent metrics of user-selected objects, metrics of all objects in the same tier, or metrics of the full set of objects associated with the service of the distributed application across the tiers. Each metric in the set of metrics Ω has an associated dynamic threshold. The operations manager constructs an anomaly count metric from the set of metrics Ω:

A^{Ω}=(Aᵢ)ᵢ₌₁^{Q}=(A(tᵢ))ᵢ₌₁^{Q} (2)
where

$$A ( {t}_{i} ) = {\sum }_{j = 1}^{θ} {c}_{ji}$$

subscript j is a metric subscript, and

$${c}_{ji} = \{ \begin{matrix}1 & if {x}_{j} ( {t}_{i} ) violates threshold \\ 0 & if {x}_{j} ( {t}_{i} ) does not violate threshold\end{matrix}$$

The metric value xⱼ(tᵢ) may also be denoted by xⱼᵢ. The parameter Aᵢ is a count of the number of metric values of the set of metrics Ω that violated corresponding thresholds at the time stamp tᵢ. When the anomaly count metric violates an anomaly count threshold for a run-time window given by

A(tᵢ)>Th_{AC} (3)

where Th_{AC} denotes an anomaly count threshold, the operations manager triggers an alert. The alert is displayed in a GUI of an administrators and/or sent in an email to the application owner indicated a performance problem.

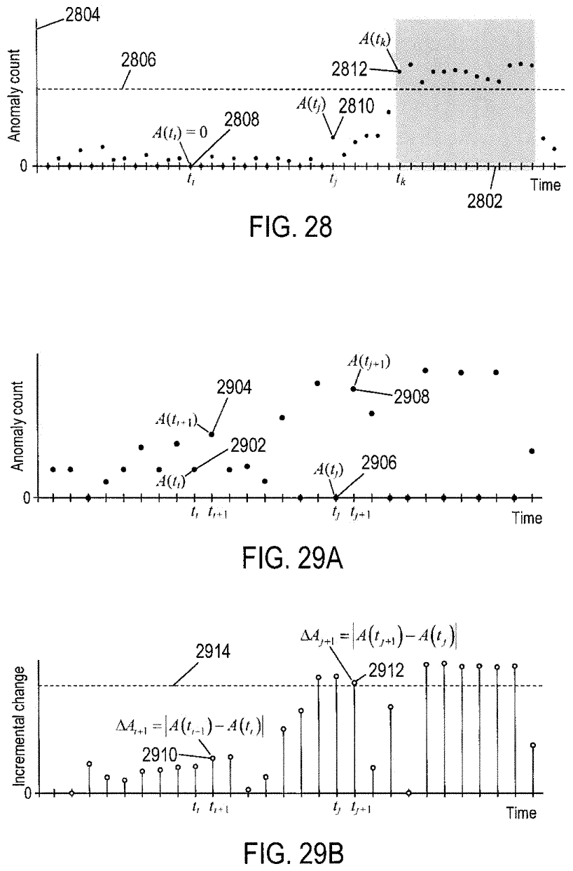

FIG. 28 shows a plot of an example anomaly count metric. Horizontal axis 2802 represents a run-time window. Vertical axis 2804 represents a range of anomaly counts for a set of metrics Ω. Marks along the time axis 2802 denote time stamps. Dashed line 2806 represents an anomaly count threshold Th_{AC}. Points represent anomaly counts of the metrics at the time stamps. For example, point 2808 represents a case where none of the metric values of the set metrics Ω at the time stamp tᵢ violated corresponding thresholds, resulting in an anomaly count of A(tᵢ)=0. Point 2810 represents a case where the total number of metric values of the set metrics Ω that violated corresponding thresholds at the time stamp tⱼ is less than the anomaly count threshold (i.e., Th_{AC}>A(tᵢ)>0). Point 2812 represents a case where the total number of metric values of the set metrics Ω that violated corresponding thresholds at the time stamp tₖ is greater than an anomaly count threshold (i.e., A(tᵢ)>Th_{AC}), which triggers an alert.

The operations manager computes anomaly count metrics in run-time windows for the full service, each of the tiers, and sets of selected objects of the service and determines the health or state of the full service, the tiers, and the selected objects. When the set of metrics Ω is the full set of metrics for the service of the distributed application, the anomaly count metric A^{Ω} represents the overall health or state of the service. When an anomaly count threshold violation occurs according to Equation (3), the operations manager generates an alert indicating there is a performance problem with the service and recommends corrective measures as described below. When the set of metrics Ω comprises metrics of the objects in a tier, such as the UI tier, the logic tier, or the data tier, the anomaly count metric A^{Ω} represents the health or state of operations performed by the tier. When an anomaly count threshold violation occurs according to Equation (3), the operations manager generates an alert indicating a performance problem with the tier and recommends corrective measures as described below. When the set of metrics Ω comprises metrics of the objects within a tier, the anomaly count metric A^{Ω} represents the health or state of that set of objects. When an anomaly count threshold violation occurs according to Equation (3), the operations manager generates an alert indicating a performance with the set of objects and recommends corrective measures as described below.

When the operations manager discovers abnormal run-time behavior in an anomaly score metric of the full service, a tier, or a set of selected objects, the operations manager computes a correlation between the anomaly score metric and each of the metrics used to construct the anomaly score metric over a run-time window. For each metric in the set of metrics Ω, a correlation coefficient is computed as follows:

$${R}_{j}^{Ω} = \frac{{\sum }_{i = 1}^{Q} ( {x}_{ji} - {\overline{x}}_{j} ) ( {A}_{i} - \overline{A} )}{\sqrt{{\sum }_{i = 1}^{Q} {( {x}_{ji} - {\overline{x}}_{j} )}^{2}} \sqrt{{\sum }_{i = 1}^{Q} {( {A}_{i} - \overline{A} )}^{2}}} \qquad ( 4 )$$

$$where$$

$${\overline{x}}_{j} = \frac{1}{Q} {{\sum }_{i = 1}}^{Q} {x}_{ji}$$

$$\overline{A} = \frac{1}{Q} {{\sum }_{i = 1}}^{Q} {A}_{i}$$

When the correlation coefficient Rⱼ^{Ω} satisfies the following condition,

|Rⱼ^{Ω}|>Th_{corr} (5)
where Th_{corr} is a threshold (e.g., Th_{corr}=0.70, 075, or 0.80).
   The operations manager identifies the corresponding metric Mⱼ and corresponding object as contributing to the abnormal health of the full service, a tier, or a set of objects in GUI and/or an email set to a systems administrator. The operations manager rank orders metrics and corresponding objects with correlation coefficients that satisfy the condition in Equation (5).

The operations manager determines unacceptable incremental changes in the anomaly count metric in order to identify potential sources of a performance problem. The operations manager computes an incremental change metric from the anomaly count metric of the full service, a tier, or selected set of objects as follows:

ΔA^{Ω}=(ΔAᵢ)ᵢ₌₁^{Q}=(ΔA(tᵢ)ᵢ₌₁^{Q} (6)
where for each pair of adjacent time stamps the incremental change is given by:

ΔAᵢ^{Ω}=|A(tᵢ)−A(tᵢ₋₁)| (7)

An incremental change is considered an unacceptable incremental change when the following condition is satisfied:

ΔAᵢ^{Ω}>Th_{inc} (8)
where Th_{inc} is an incremental change threshold.

FIG. 29A shows a plot of an example anomaly count metric. Points 2902 and 2904 represent a pair of adjacent anomaly counts A(tᵢ) and A(tᵢ₊₁), respectively. Points 2906 and 2906 represent a different pair of adjacent anomaly counts A(tⱼ) and A(tⱼ₊₁), respectively. FIG. 29B shows a plot of incremental changes in the anomaly counts of FIG. 29A. For example, point 2910 represents the incremental change ΔAᵢ₊₁, between the anomaly counts A(tᵢ) and A(tⱼ₊₁) and point 2912 represents the incremental change ΔAⱼ₊₁ between the anomaly counts A(tⱼ) and A(tⱼ₊₁). In the example of FIG. 29B, dashed line 2914 represents the incremental change threshold. Because incremental change ΔAⱼ₊₁ 2912 is greater than the incremental change threshold 2914, incremental change ΔAⱼ₊₁ 2912 is identified as a unacceptable incremental change. By contrast, because incremental change ΔAᵢ₊₁ 2910 is less than the incremental change threshold 2914, incremental change ΔAᵢ₊₁ 2910 is an acceptable incremental change.

When the operations manager identifies unacceptable incremental changes for the full service, the operations manager determines how unacceptable increment changes are distributed across tiers. When a tier is identified as having one or more unacceptable incremental changes, the operations manager identifies objects in the tier that exhibit one or more unacceptable incremental changes at the same time stamps. The operations manager displays an alert in a GUI and/or generates an email sent to systems administrator identifying the service as exhibiting a performance problem, the tier exhibiting a performance problem, and objects of the tier that are also exhibiting performance problems.

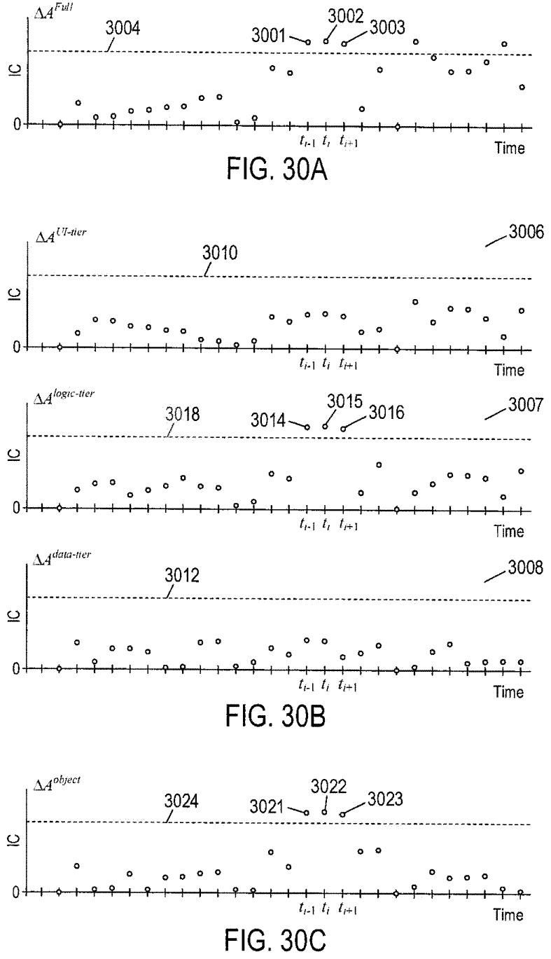

FIGS. 30A-30C show an example of determining unacceptable incremental changes across tiers and an object of a tier. FIG. 30A shows a plot of an example incremental change metric ΔA^{Full} obtained for a service based on metrics obtained for the full set objects in three tiers of the service. Points 3001-3003 represent three unacceptable incremental changes that exceed the incremental change threshold 3004 at the time stamps tᵢ₋₁, tᵢ, and tᵢ₊₁. In response to the three threshold violations, the operations manager computers incremental change metrics for the three tiers of the service denoted by ΔA^{UI-tier}. ΔA^{logic-tier}, ΔA^{data-tier}, over the same time interval. FIG. 30B shows plots 3006-3008 of three example incremental change metrics for the UI-tier, the logic tier, and the data tier, respectively, of the service. Plot 3006 is the incremental change metric ΔA^{UI-tier} for the UI tier. Plot 3007 is the incremental change metric ΔA^{logic-tier} for the logic tier. Plot 3008 is the incremental change metric ΔA^{data-tier} for the data tier. The incremental change metrics ΔA^{UI-tier} and ΔA^{data-tier} do not violate corresponding incremental change thresholds 3010 and 3012. On the other hand, for incremental change metric ΔA^{logic-tier}, points 3014-3016 represent three unacceptable incremental changes that exceed the incremental change threshold 3018 at the time stamps tᵢ₋₁, tᵢ, and tᵢ₊₁. In response to the three threshold violations in the logic tier, the operations manager computers incremental change metrics from metrics of the objects comprising the logic tier. FIG. 30C shows a plot of an example incremental change metric ΔA^{object} for an object of the logic tier. Points 3021-3023 represent three unacceptable incremental changes that exceed the incremental change threshold 3024 at the time stamps tᵢ₋₁, tᵢ, and tᵢ₊₁. The operations manager displays in a GUI an alert identifying the service as exhibiting a performance problem, an alert identifying the logic tier as exhibiting a performance problem, and an alert identifying the objects as exhibiting a performance problem.

The operations manager uses machine learning to perform run-time detection of anomalous behaving objects and tiers. A tier is a population of objects with similar functions. In other words, objects in a tier are expected to exhibit similar behavior in run-time windows. The operations manager detects dissimilar objects based on changes in distributions of events recorded in metrics and uses machine learning to construct metric-association rules that can be used by the operations manager to identify a performance problem with a service and generate a recommendation for correcting the performance problem.

The operations manager constructs a histogram for each metric of each object in a tier for a run-time window. The range of possible metric values of each metric is partitioned using thresholds represented as follows:

u₁< . . . <uₗ< . . . <u_{L} (9)
where
   u₁ is a lowest threshold;
   uₗ is an intermediate threshold;
   U_{L} is a highest threshold; and
   subscript l is a threshold index l=1, . . . , L with L the number of thresholds.
      The range of metric values between each pair of adjacent thresholds defines a bin for metric values. For example, when a metric value xᵢ lies between two adjacent thresholds uₗ and uₗ₊₁ (i.e., uₗ<xᵢ<uₗ₊₁) a counter associated with the range of metric values between uₗ and uₗ₊₁ is incremented.

In practice, the thresholds used to construct histograms for the metrics may range from as few as two thresholds to a user-selected number of thresholds. For the sake of simplicity in the following description, four thresholds are used to construct five bins. The four thresholds are represented by:

u₁<u₂<u₃<u₄ (10)

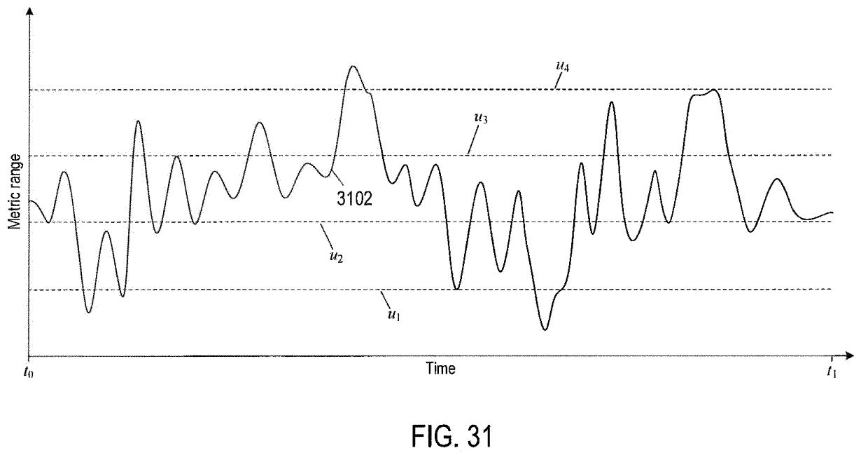

FIG. 31 shows a plot of an example metric 3102 with metric values recorded in a run-time window defined by [t₀, t₁] and four thresholds represented by horizontal dashed lines and labeled u₁, u₂, u₃, and u₄. The thresholds partition a range of metric values associated with the metric 3102. A histogram of the metric is obtained by counting the number of metric values within each subrange of metric values created by the thresholds.

Let c₀ denote a counter for metric values in the subrange 0≤xᵢ<u₁, c₁ denote a counter for metric values in the subrange u₁≤xᵢ<u₂, c₂ denote a counter for metric values in the subrange u₂≤xᵢ<u₃, c₂ denote a counter for metric values in the subrange u₂≤xᵢ<u₃, c₃ denote a counter for metric values in the subrange u₃≤xᵢ<u₄, and c₄ denote a counter for metric values in the subrange u₄≤xᵢ. The counters c₀, c₁, c₂, c₃, and c₄ are initialized to zero for each run-time window. The following pseudocode represents a method of counting the number of metric values that lie in five subranges of the range of metric values created by the four thresholds:

| | |
|---|---|
| 1 | c₀ = c₁ = c₂ = c₃ = c₄ = 0; // initialize bin counters |
| 2 | for (i = 1; i ≤ N; i ++) { |
| 3 | if (0 ≤ xᵢ < u₁) |
| 4 | c₀ += 1; |
| 5 | if (u₁ ≤ xᵢ < u₂ ) |
| 6 | c₁ += 1; |
| 7 | if (u₂ ≤ xᵢ < u₃) |
| 8 | c₂ += 1; |
| 9 | if (u₃ ≤ xᵢ < u₄) |
| 10 | c₃ += 1; |
| 11 | if (u₄ ≤ xᵢ) |
| 12 | c₄ += 1; |
| 13 | } |

The operations manager computes a relative frequency of metric values in each subrange of the range of metric values as follows:

$${p}_{l} = \frac{{c}_{l}}{{N}_{1}^{rtw}} \qquad ( 11 )$$

where
   l=0, 1, . . . , L is a bin index; and
   N₁^{rtw} is the number of metric values in the run-time window [t₀, t₁].
      The relative frequencies distribution (p₀, . . . , p_{L}) form a relative frequency distribution for the run-time window [t₀, t₁]. The operations manager computes a relative frequency distribution (q₀, . . . , q_{L}) for a subsequent run-time window [t₁, t₂], where qₗ=cₗ/N₂^{rtw} and N₂^{rtw} is the number of metric values in the subsequent run-time window [t₁, t₂]

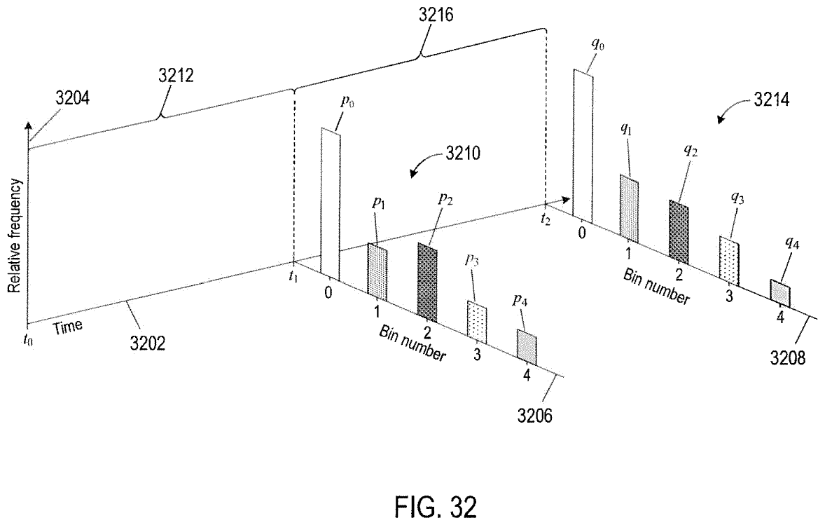

FIG. 32 shows two distributions of relative frequencies computed for two adjacent run-time intervals. Axis 3202 represents time. Axis 3204 represents a range of relative frequencies. Axes 3206 and 3208 represent bin numbers. A first relative frequency distribution (p₀, p₁, p₂, p₃, p₄) 3210 is calculated from the set of metric data generated over the run-time interval [to, t₁] 3212. A second relative frequency distribution (q₀, q₁, q₂, q₃, q₄) 3214 is calculated from the set of metric data generated over a subsequent run-time interval [t₁, t₂]3216.

The operations manager computes a divergence between relative frequency distributions in consecutive run-time intervals. The divergence is a quantitative measure of a change in behavior of an object based on changes in the relative frequency distribution from one run-time interval and to a subsequent run-time interval. The divergence between consecutive run-time relative frequency distributions is computed using the Jensen-Shannon divergence:

$$D = - {{\sum }_{l = 0}}^{L} {m}_{l} log {m}_{l} + \frac{1}{2} [ {{\sum }_{l = 0}}^{L} {p}_{l} log {p}_{l} + {{\sum }_{l = 1}}^{L} {q}_{l} log {q}_{l} ] \qquad ( 12 )$$

where mₗ=(pₗ+qₗ)/2.

The divergence D computed is a normalized value that satisfies the condition

0≤D≤1 (13)

The closer the divergence is to zero, the closer the first relative frequency distribution is to matching the second relative frequency distribution. For example, when D=0, the first relative frequency distribution is identical to the second relative frequency distribution. On the other hand, the closer the divergence is to one, the farther the first and second relative frequency distributions are from one another. For example, when D=1, the first and second relative frequency distributions are different and unrelated. When the divergence satisfies the condition

D>Th_{div} (14)

where Th_{div} is a divergence threshold, the operations manager generates an alert indicating the state or health of an object in a tier has changed, which may be an indication of a performance problem.

The operations manager also computes a divergence between pairs of similar objects of the same tier. Because a tier comprises objects with similar functions, these objects are expected to exhibit similar behavior in the same run-time windows. Consider a first object and a second object in the same tier. The objects may be VMs or containers that perform the same or similar functions. Let (p₀, . . . , p_{L}) represent a relative frequency distribution of the first object and let (q₀, q_{L}) represent a relative frequency distribution for the second object, where the relative frequency distributions are obtained for the same run-time interval. The operations manager computes the divergence D between the two objects. When the divergence satisfies the condition in Equation (14), the operations manager generates an alert in a GUI and/or an email sent to a systems administrator indicating that the two objects of the tier have diverged and are no longer behaving in the same manner.

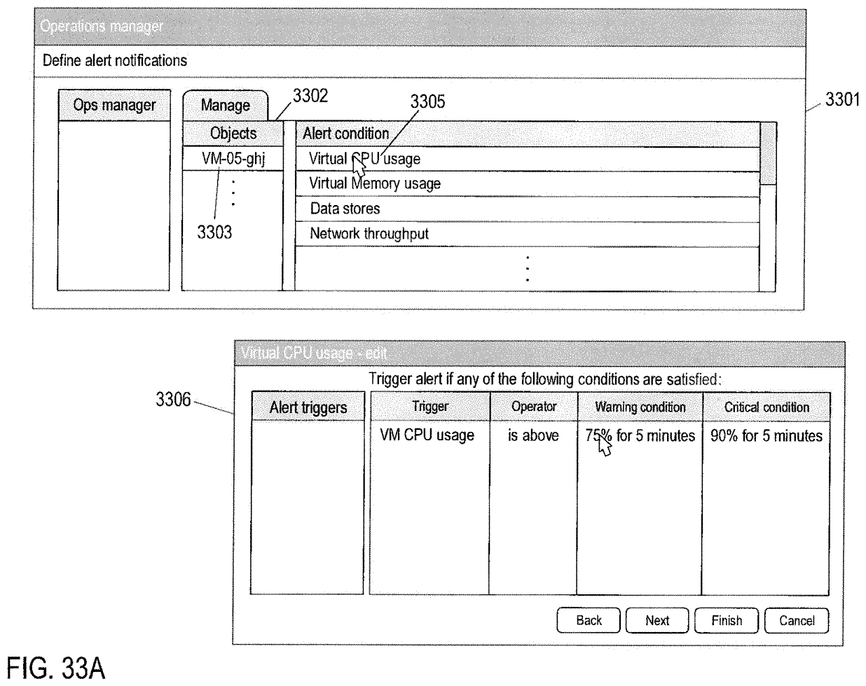

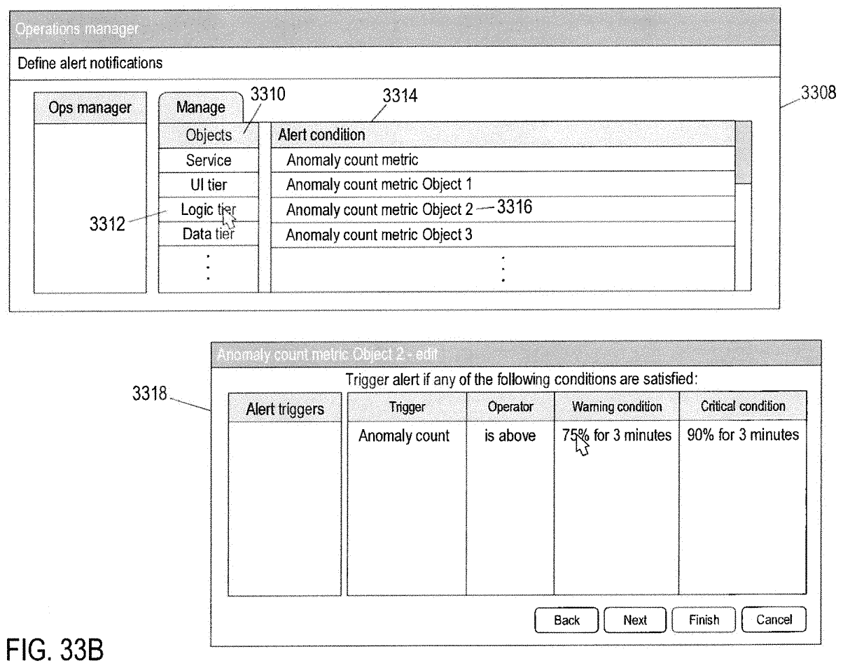

The operations manager provides a GUI that enable a user to select alert conditions for each of the metrics described above. FIGS. 33A-33B show examples of GUIs that enable a user to selected alert levels and durations of threshold violations. FIG. 33A shows a GUI 3301 that includes a field 3302 for selecting an object. In this example, the selected object is a VM with name 3303. A field 3304 contains a list of metrics a user may choose from. In this example, a selects a “Virtual CPU usage” metric by clicking on the name of the metric 3305, which opens a separate window 3306. The window 3306 enables a user to select conditions for generating an alert, such as “is above” a threshold for the metric, generates a warning alert when 75% of the metric values violate the threshold for a run-time window of 5 minutes, and generates a critical alert when 90% of the metric values violate the threshold for a run-time window of 5 minutes. The user can adjust the percentage and the duration of the run-time window. FIG. 33B shows a GUI 3308 that includes a field 3310 for selecting the service or one of the tiers of the service. In this example, the selected object is a logic tier 3312. A field 3314 contains a list of metrics a user may choose from. In this example, a user selects a “Anomaly count metric Object 2,” which anomaly count metric formed from aggregating the metrics of the Object 2 in the logic tier. By clicking on the name of the metric 3316, a separate window 3318 is opened. The window 3318 enables a user to select conditions for generating an alert, such as “is above” a threshold for the anomaly count metric, generates a warning alert when 75% of the anomaly count metric values violate the threshold for a run-time window of 3 minutes, and generates a critical alert when 90% of the anomaly count metric values violate the threshold for a run-time window of 3 minutes. The user can adjust the percentage and the duration of the run-time window.

The operations manager provides a GUI that enables a user to select one or more key performance indicator (“KPIs”) to represent the state, or health, of a service, a tier, and objects of a distributed application over time. Examples of KPIs include latency, traffic, errors, and saturation, examples of which are shown in FIGS. 27A-27F. Application latency is the time delay between a time when a client submits a request for an application to perform an operation, or provide a service, and a later time when the application responds to the request. Traffic is the number of requests processed by an application per unit time. Errors are the number of application errors per unit time because of the application processing client requests or accessing resources. Saturation is the percentage, or number, of resources used by the application per unit time. Anomaly count metrics and incremental change metrics for the service, the tiers, and certain objects may be selected as KPIs in the GUI. KPIs also include summing selected normalized metrics:

$$KPI = {{\sum }_{j = 1}}^{J} {\overline{x}}_{j} ( {t}_{i} ) \qquad ( 15 a )$$

where
   j is an index of metrics selected to form the KPI;
   J is the number of selected metrics;

$${\overline{x}}_{i} = \frac{{x}_{i} - min ( M )}{max ( M ) - min ( M )}$$

min(M) is the minimum metric value of the metric M; and
max(M) is the maximum metric value of the metric M.
   A KPI may be an average of selected normalized metrics generated at each time stamp:

$$KPI = \frac{1}{J} {{\sum }_{j = 1}}^{J} {\overline{x}}_{j} ( {t}_{i} ) \qquad ( 15 b )$$

A KPI may be the largest metric generated at each time stamp:

KPI=max{xⱼ(tᵢ)}ⱼ₌₁^{J} (15c)

A KPI may be the smallest metric generated at each time stamp:

KPI=min{xⱼ(tᵢ)}ⱼ₌₁^{J} (15d)

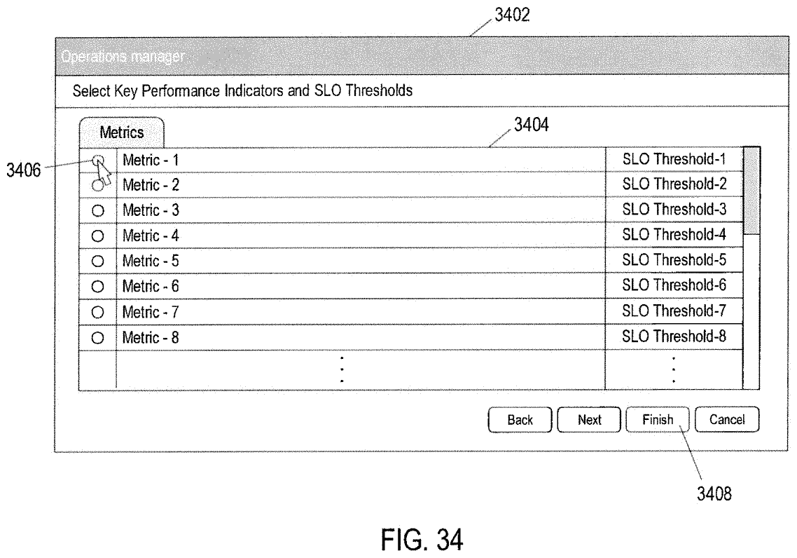

FIG. 34 shows an example of a GUI 3402 that enables a user to select which metrics to use as KPIs for assessing the overall state of a distributed application. In this example, the GUI 3402 includes a field 3404 with a list of metrics and identifies the associated service-level objective (“SLO”) thresholds. An SLO can be a desired performance level for the service, tier, or object. For example, a response time SLO of the application to a user request may be 0.5 seconds or a CPU usage SLO for a processor may be 55%. When a KPI violates a corresponding SLO threshold, the service, tier, or object has entered an unhealthy or abnormal state and the application has a performance problem. A user selects a metric by clicking on the button, such as button 3406, and may set the SLO threshold or select a dynamic threshold. After the user selects one or more metrics as KPIs, the user clicks on the “finish” button 3408 and the selected metrics are utilized as KPIs by the operations manager in evaluating the health of the service provided by the distributed application.

A KPI is an indication of the overall health or state of a service, tier, or one or more objects. But a KPI alone may not be useful in identifying the root cause of a performance problem exhibited in an unhealthy state of the service, tier, or objects of a distributed application. For example, suppose a user selects response time of a service provide by a distributed application as a KPI. When the response time violates a corresponding response time threshold, an alert is triggered and displayed in a GUI and/or email sent to a system administrator indicating that the distributed application has entered an unhealthy state in which the response time is unacceptable. But there is no way of knowing from the alert alone the root cause of the performance problem that created the delayed response times. For example, a delayed response time may result from one or more problems with CPU usage, memory usage, and network throughput of VMs or a host. Troubleshooting a problem identified by KPIs have traditionally been handled by teams of software engineers with the aid of typical management tools, such as workflows and domain experience to try and troubleshoot the root cause of the performance problem. However, even with the aid of typical management tools, the troubleshooting process is error prone and because there are numerous other underlying problems that contribute to abnormalities recorded in a KPI, typical manual troubleshooting processes can take weeks and, in some cases, months to determine the actual root cause of a performance problem.

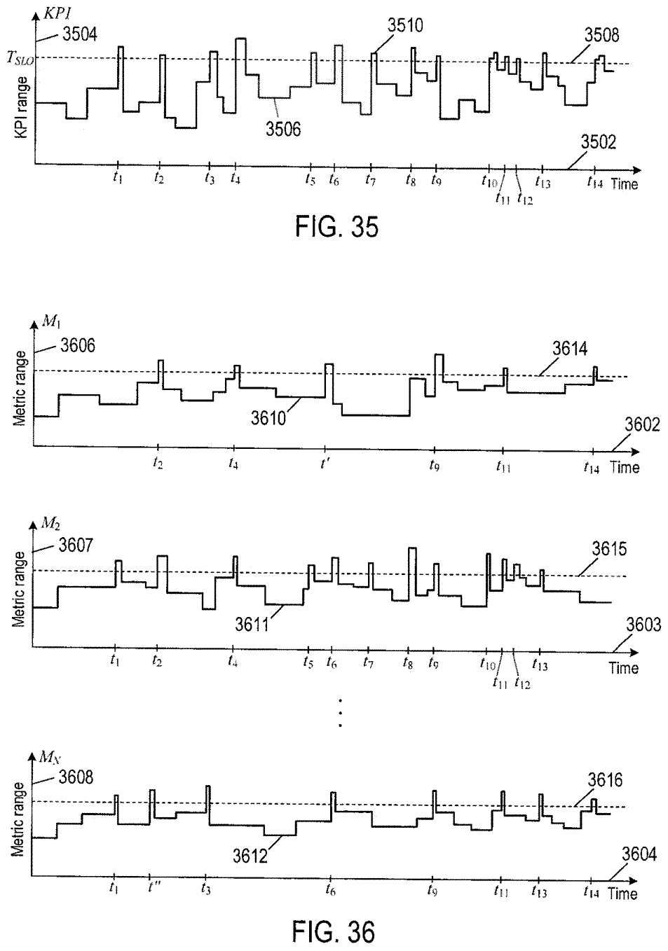

The operations manager uses machine learning to obtain a metric-associated rule that can be used to identify the performance problem with the distributed application and generate a recommendation for correcting the performance problem. A metric-association rule comprises metrics of resources and/or objects that contribute to a KPI violation, thereby eliminating the error prone and time-consuming workflows and reliance on domain experience to detect the problem. One implementation for determining metric-association rules is described below with reference to FIGS. 35-42.

FIG. 35 shows a plot of an example KPI recorded in a run-time window. Horizontal axis 3502 represents time. Vertical axis 3504 represents a range of values for the KPI. Curve 3506 represent metric values of the KPI. Dashed line 3508 represents an SLO threshold represents a limit on normal behavior for a service provided by a distributed application, a tier of the application, an object in a tier. The SLO threshold may be user selected or a dynamic threshold. Time axis 2502 includes fourteen marks denoted by tᵢ, where i=1, . . . 14, that represent time stamps when the KPI violates the SLO threshold 3508 during run-time. For example, KPI value 3510 violates the threshold 512 at a time stamp t₇.

FIG. 36 shows plots of three example metrics of N metrics associated with the KPI in FIG. 35. The metrics are denoted by Mₙ, where n=1, . . . , N, and the metrics are collected in the same run-time window as the KPI shown in FIG. 35. For example, the KPI in FIG. 35 may have been selected to represent the health of a tier and the N metrics are metrics of objects in the tier. In another example, the KPI in FIG. 35 may have been selected to represent the health of an object and the N metrics are metrics of resources used by the object. Horizontal axes 3602-3604 represent time. Vertical axes 3606-3608 represent ranges of metric values for the associated metrics. Curves 3610-3612 represent the metrics. For example, metric M₁ may denote CPU usage, metric M₂ may denote memory usage, and metric M_{N} may denote I/O network usage. Dashed lines 3614-3616 represent dynamic thresholds associated with each metric. The time axes 3602-3604 include marks that represents time stamps when the metrics violated corresponding thresholds 3614-3616. For example, metrics 3610 and 3611 violate corresponding thresholds 3614 and 3615 at same time stamp t₂. Threshold violations occur at different time stamps, but the time stamps may correspond to KPI violations of the SLO threshold. For example, metrics M₁ and M₂ violate corresponding thresholds at time stamp t₂, which correspond to the KPI violation of the SLO threshold at time stamp t₂ in FIG. 35. On the other hand, it may be the case that metrics violate corresponding thresholds at time stamps that do not correspond to any of the time stamps when the KPI violated the SLO threshold 3508. For example, metrics M₁ violates the threshold 3614 at time stamp t′ and metric M_{N} violates the threshold 3616 at time stamp t″. The time stamps t′ and t″ do not correspond to KPI violations of the SLO threshold 3508.

Note that although methods are described below for the SLO threshold of FIG. 35 and thresholds of FIG. 36 represent upper bounds on normal behavior, methods described below may be used with an SLO threshold and thresholds that are lower bounds on normal behavior.

The operations manager computes a participation rate. KPI degradation rate, and co-occurrence rate for each metric associated with the KPI over the run-time window for time stamps that correspond to violations of metric thresholds and KPI violations of an SLO threshold. The participation rate is a measure how much, or what portion, of the metric threshold violations correspond to SLO threshold violations in the run-time window. For each metric, a participation rate is calculated as follows:

$${Part}_{rate} ( {M}_{n} ) = \frac{count ( TS ( {M}_{n} ) ⋂ TS ( KPI ) )}{count ( TS ( KPI ) )} \qquad ( 16 )$$

where
   TS(Mₙ) is the set of time stamps where metric Mₙ violated the threshold in the run-time window;
   TS(KPI) is the set of time stamps when the KPI violated the SLO threshold in the run-time window;
   ∩ denotes intersection operator; and
   count(.) is a count function that counts the number of elements in a set.

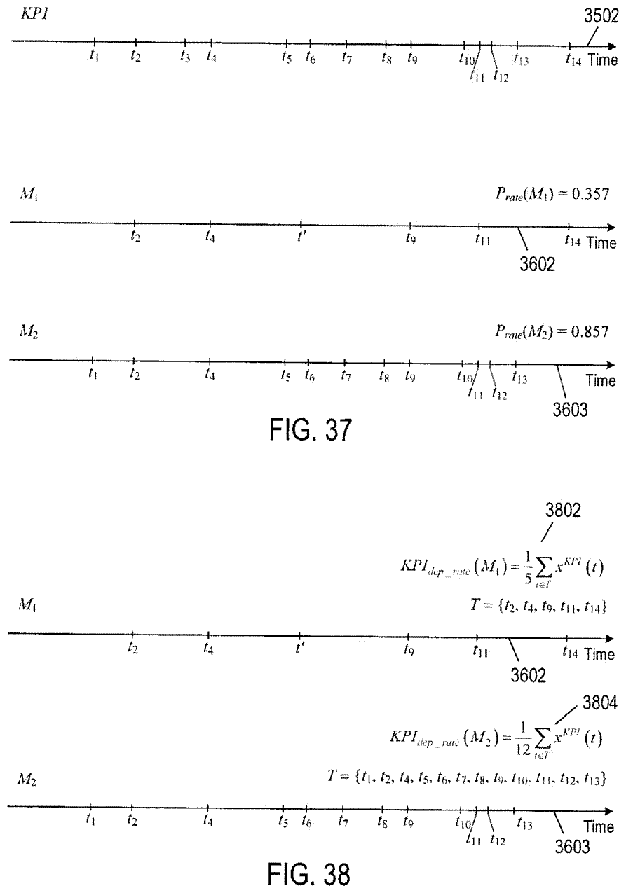

FIG. 37 shows time stamps when the KPI and metrics M₁ and M₂ violated associated thresholds. FIG. 37 shows the time axis 502 of the KPI and the fourteen time stamps that correspond to violations of the SLO threshold 3508 described above with reference to FIG. 35. The time axes 3602 and 3603 represent time stamps of threshold violations for the metrics M₁ and M₂ in FIG. 36. The participation rates of the metrics M₁ and M₂ are calculated according to Equation (16). For example, the set of time stamps of the metric M₁ that violated the threshold 3614 is

TS(M₁)={t₂,t₄,t′,t₉,t₁₁,t₁₄}

the set of time stamps of the KPI that violated the SLO threshold 3508 is

TS(KPI)={t₁,t₂,t₃,t₄,t₅,t₆,t₇,t₈,t₉,t₁₀,t₁₁,t₁₂,t₁₃,t₁₄}

The intersection of the sets of time stamps TS(M₁) and TS(KPI) is

TS(M₁)∩TS(KPI)={t₂,t₄,t₉,t₁₁,t₁₄}

The counts are

count(TS(An)∩TS(KPI))=5

and

count(TS(KPI))=14

which gives a participation rate of Pᵣₐₜₑ(M₁)=0.357. The participation rate of the metric M₂ is similarly calculated to be Pᵣₐₜₑ(M₂)=0.857. The participation rate, Pᵣₐₜₑ(M₁)=0.357, indicates that metric M₁ corresponds to about 35% of the KPI violations of the SLO threshold 3508 and the participation rate Pᵣₐₜₑ((M₂)=0.857 indicates that attribute M₂ corresponds to about 85% of the KPI violations of SLO threshold 3508.

The operations manager computes a degradation rate for each of the metrics M₁, . . . , M_{N} as a measure of how each metric degrades the performance of the application based on the KPI. The degradation rate is calculated as an average of the KPI at the time stamps when both the KPI violated the SLO threshold 3508 and the metric violated a corresponding threshold and is given by

$$\text{?} ( {M}_{n} ) = \frac{1}{count ( T )} {\sum }_{t ∈ T} {x}^{KPI} ( t ) \qquad ( 17 )$$

$$\text{?} \text{indicates text missing or illegible when filed}$$

where
   T=TS(M₁)∩TS(KPI); and
   x^{KPI}(t) is the value of the KPI at time stamp t.

FIG. 38 shows time stamps when the KPI and metrics M₁ and M₂ violated associated thresholds. FIG. 38 show equations 3802 and 3804 that represent calculation of the KPI degradation rate for the metrics M₁ and M₂ in accordance with Equation (17). The KPI_{deg_rate}(M₁) is an average of KPI values that violated the SLO threshold at the time stamps t₂, t₄, t₉, t₁₁, and t₁₄.

The operations manager computes a co-occurrence index for each of the metrics M₁, . . . , M_{N}. The co-occurrence index as an average number of co-occurring metric threshold violations between two metrics. The time stamps of the co-occurring metric threshold violations also coincide with the time stamps of the KPI violations of the SLO threshold. The co-occurrence index is given by:

$${Co}_{index} ( {M}_{n} ) = \frac{1}{N - 1} {{\sum }_{{j = 1}_{j \neq n}}}^{N} count ( TS ( {M}_{n} ) ⋂ TS ( {M}_{j} ) ) \qquad ( 18 )$$

where
   TS(Mₙ) is the set of time stamps when Mₙ violated a corresponding threshold;
   TS(Mⱼ) is the set of time stamps when Mⱼ violated a corresponding threshold; and
   count (TS(Mₙ)∩TS(Mⱼ)) is the number of same time stamps where the metrics Mₙ and Mⱼ violate their respective thresholds.

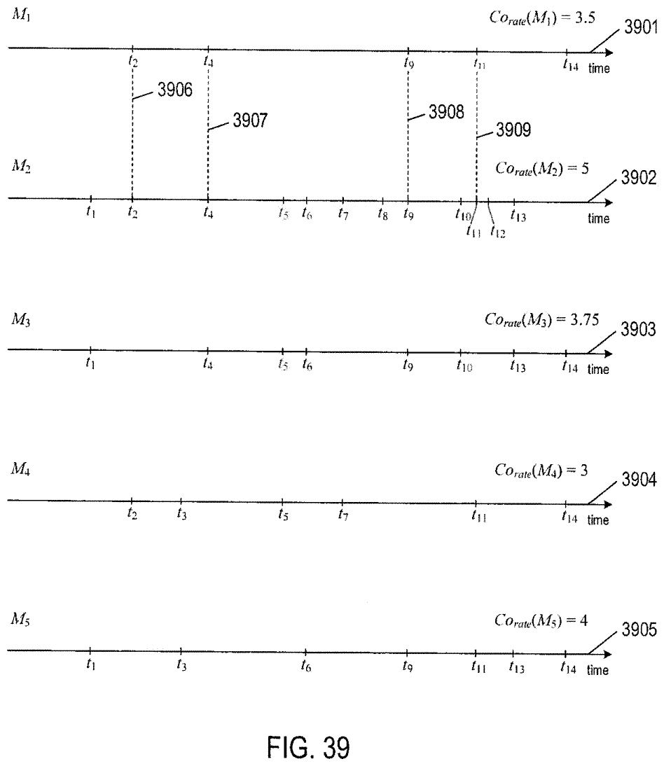

FIG. 39 shows time axes 3901-3905 of five metrics with marks identifying time stamps of corresponding metric threshold violations. The time stamps coincide with time stamps of the KPI violations of the SLO threshold in FIG. 35. The count(M₁∩M₂)=4 is the number of times the metrics M₁ and M₂ violated corresponding thresholds at the same time stamps as indicated by dashed lines 3906-3909. The quantities count(M₁∩M₃), count(M₁∩M₄), and count(M₁∩M₅) are calculated in the same manner. The co-occurrence index for the metric M₁ is given by:

Co_{index}(M₁)=¼(4+3+3+4)=3.5

The co-occurrence indices associated with the metrics M₁, M₂, M₃, M₄, and M₅ are presented in FIG. 39.

The participation rate. KPI degradation rate, and co-occurrence index are used to identify metrics that are associated with abnormal behavior represented in the KPI. Any one or more of the following conditions may be used to identify a metric. Mₙ, as a metric that contributes to abnormal, or unhealthy, behavior represented in the KPI:

Partᵣₐₜₑ(Mₙ)>Th_{P} (19a)

KPI_{deg_rate}(Mₙ)>Th_{SDR} (19b)

Co_{index}(Mₙ)>Th_{CO} (19c)
where
   Th_{P} is the participation rate threshold;
   Th_{SDR} is the SLO metric degradation rate threshold; and
   hT_{CO} is the co-occurrence index threshold.
      Metrics that satisfy the conditions in one or more of Equations (19a)-(19c) are considered metrics of interest.

The operations manager determines combinations of metrics that satisfy at least one of the conditions in Equation (19a)-(19c). In other words, the operations manager determines combinations of metrics from the metrics of interest. The operations manager uses machine learning to determine which combinations of metrics become “metric-association rules.” Consider, for example, metrics that are associated with abnormal behavior represented in the KPI because one or more corresponding participation rates, KPI degradation rates, and co-occurrence indices satisfy the conditions in Equation (19a)-(19c). The operations manager discovers combinations of metrics that violate associated thresholds at the same time stamps. For example, the set of metrics {M₁, M₂} is a combination of metrics, if metric M₂ violates a corresponding threshold at the same time stamps that metric M₁ violates a corresponding threshold. A third metric M₃ may be combined with the metrics M₁ and M₂ to form another combination of metrics {M₁, M₂, M₃} if the metric M₂ violates a corresponding threshold at the same time stamps the metrics M₁ and M₂ violate corresponding thresholds.

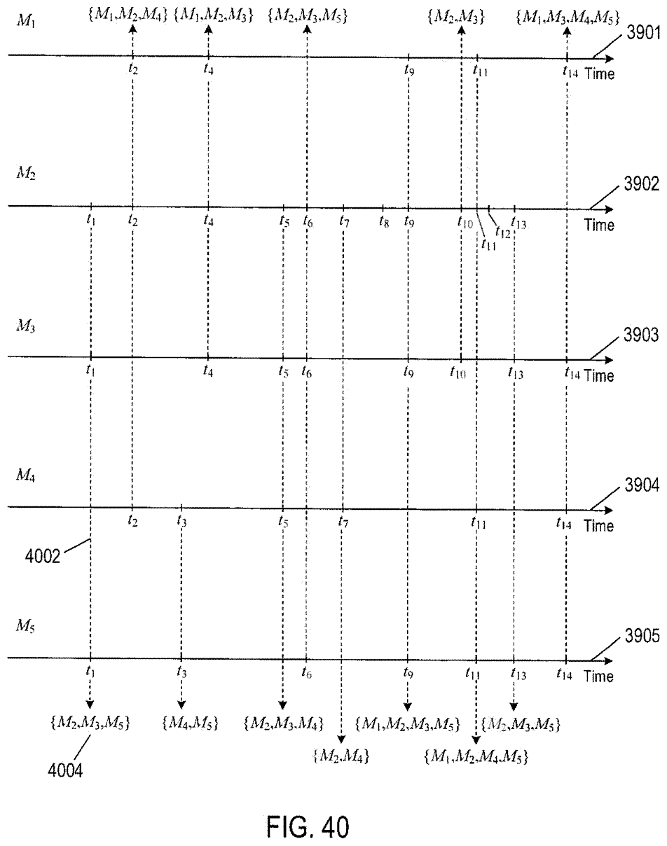

FIG. 40 shows an example of combinations of metrics created from the five metrics described above with reference to FIG. 39. Dashed-line arrows identify metric values of different metrics that violate corresponding thresholds at the same time stamps. For example, dashed-line arrow 4002 indicates that metrics M₂, M₃, and M₅ violate corresponding thresholds at the same time stamp t₁. As a result, the metrics M₂, M₃, and M₅ form a combination of metrics {M₂, M₃, M₄} 4004. Note that metric M₂ is the only metric that violates a corresponding threshold at the time stamps t₈ and t₁₂. Therefore, combinations of metrics do not exist for the time stamps t₈ and t₁₂.

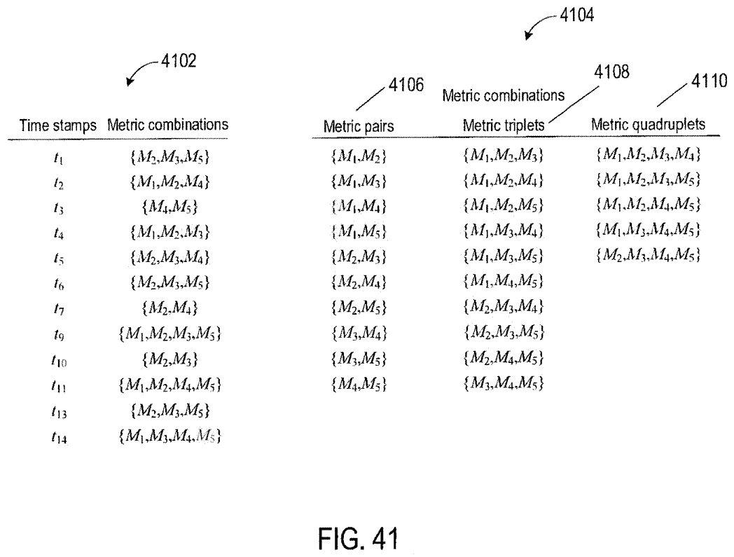

The operations manager creates combinations of metrics. FIG. 41 shows a table 4102 of combinations of metrics and associated time stamps identified in FIG. 40. Table 4104 is a list of all possible combinations of metric that can be formed from five metrics M₁, M₂, M₃, M₄ and M₅. Column 4106 list all combinations of metrics that can be formed with two of the five metrics M₁, M₂, M₃, M₄ and M₅; column 4108 list all combinations of metrics that can be formed with three of the five metrics M₁, M₂, M₃, M₄ and M₅; and column 4110 list all combinations of metrics that can be formed with four of the five metrics M₁, M₂ M₃, M₄ and M₅.

A metric-association rule is determined from a combination probability calculated for each combination of metrics. Only combinations of metrics with an acceptable corresponding combination probability form a metric-association rule. The operations manager computes a combination probability for each combination of metrics as follows:

$${P}_{comb} ( metric combination ) = \frac{freq ( metric combination )}{number of metric patterns} \qquad ( 20 )$$

where
   metric combination represents a combination of metrics formed from metric pair, metric triplet, metric quadruplet etc.; and
   freq(metric combination) is the number of occurrences of the combination of metrics in the combinations of metrics that violated corresponding thresholds at the same time stamps.
      When a combination probability of a combination of metrics is greater than a combination threshold:

P_{comb}(metric combination)≥Thₚₐₜₜₑᵣₙ (21)

where Thₚₐₜₜₑᵣₙ is a user-selected combination threshold, the combination of metrics is designated as a metric-association rule.

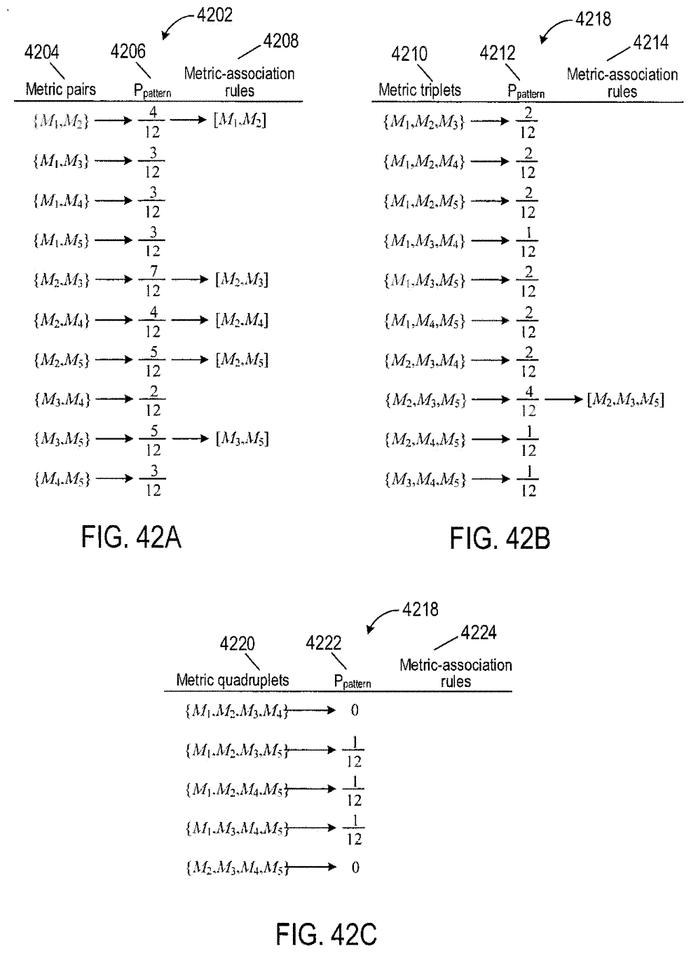

FIGS. 42A-42C show an example of determining metric-association rules from the metric combinations shown in FIG. 41. In FIG. 42A, table 4202 includes a column of the metric pairs 4204 of the five metrics M₁, M₂, M₃, M₄ and M₅. Column 4206 lists the combination probabilities calculated for each of the pairs listed in column 4204 according to Equation (20). In this example, using an example combination threshold of Tₚₐₜₜₑᵣₙ=4/12, as described above with reference to Equation (21), gives metric-association rules [M₁, M₂], [M₂, M₃], [M₂, M₅], and [M₃, M₅] listed in column 4208. In FIG. 42B, table 4210 includes a column of the metric triplets 4212 of the five metrics M₁, M₂, M₃, M₄ and M₅. Column 4214 lists the combination probabilities calculated for each of the metric triplets according to Equation (20). Using the combination threshold of Tₚₐₜₜₑᵣₙ=4/12 as described above with reference to Equation (21) gives only one metric-association rules [M₂, M₃, M₅] listed in column 4216. In FIG. 42C, table 4218 includes a column of the metric quadruplets 4220 of the five metrics M₁, M₂, M₃, M₄ and M₅. Column 4222 lists the combination probabilities calculated for each of the metric quadruplets according to Equation (20). None of the combination probabilities is greater than the combination threshold of Tₚₐₜₜₑᵣₙ=4/12. As a result, there are no metric-association rules for the metric quadruplets.

The operations manager computes the participation rate. KPI degradation rate, and co-occurrence rate for each metric-association rule:

$${Part}_{rate} ( metric - ass rule ) = \frac{count ( TS ( metric - ass rule ) ⋂ TS ( KPI ) )}{count ( TS ( KPI ) )} \qquad ( 22 )$$

where metric−ass rule is a metric-association rule of two or more metrics; and TS(metric−ass rule) is the set of time stamps of the metric-association rule in the run-time window.

For example, in FIG. 37, the set of time stamps of the metric-association rule [M₁, M₂] is given by:

TS([M₁,M₂])={t₁,t₂,t₄,t₅,t₆,t₇,t₈,t₉,t₁₀,t₁₁,t₁₂,t₁₃t₁₄}

which is the full set of time stamps when metrics M₁ and M₂ violate corresponding thresholds. As a result, the participation rate of the metric-association rule [M₁, M₂] is Partᵣₐₜₑ(metric−ass rule)=0.92.

The operations manager computes the KPI degradation rate of a metric-association rule is the maximum of the KPI degradation rate of the metrics that form a metric-association rule:

KPI_{deg_rate}(metric−ass rule)=max{KPI_{deg_rate}(Mⱼ)}ⱼ₌₁^{J} (23)
where KPI_{deg_rate}(Mⱼ) is the KPI degradation rate of the j-th metric, Mⱼ, of the metric-association rule.

The operations manager computes a co-occurrence index of a metric-association rule as the average of the co-occurrence indices of the metrics that form the metric-association rule:

$${Co}_{rate} ( metric - ass rule ) = \frac{1}{J} {{\sum }_{j = 1}}^{J} {Co}_{rate} ( {M}_{j} ) \qquad ( 24 )$$

The operations manager computes the participation rate, KPI degradation rate, and co-occurrence index for each metric-association rule according to Equations (22)-(24). Metric-association rules that the satisfy one or more of the conditions of the following conditions

Partᵣₐₜₑ(metric−ass rule)>Th_{P} (25a)

KPI_{deg_rate}(metric−ass rule)>Th_{SDR} (25b)

Co_{index}(metric−ass rule)>Th_{CO} (25c)

are identified as metric-association rules of interest.

The operations manager also combines metrics with metric-association rules to determine if one of more metrics can be added to the metric-association rules. Let {Mᵢ}_{i∈I}, where I is a set of indices of metrics that the satisfy the conditions in Equations (25a)-(25c). For each metric of Mᵢ not already part of a metric-association rule, a conditional probability of the metric Mᵢ with respect to the metric-association rule is calculated as follows:

$${P}_{con} ( {M}_{i} \vert metric - ass rule ) = \frac{freq ( {M}_{i} )}{freq ( mertics in mertic - ass rule )} \qquad ( 26 )$$

where
   freq(Mᵢ) is the frequency of the metric Mᵢ in the combination of metrics; and
   freq(mertics in mertic−ass rule) is the frequency of the metrics that form the metric-association rule.
      When the conditional probability satisfied the following condition:

P_{con}(Mᵢ|metric−ass rule)≥Th_{R} (27)

where Th_{R} is a conditional-probability threshold, the metric Mᵢ may be combined with the metric-association rule to create another metric-association rule. For example, the conditional probability of the metric M₄ with respect to the metric-association rule [M₁, M₂] is given by

$$P ( {M}_{4} \vert [ {M}_{1} , {M}_{2} ] ) = \frac{freq ( {M}_{4} )}{freq ( {M}_{1} and {M}_{2} )} = \frac{6}{10 + 5} = 0.4$$

If the threshold Th_{R}=0.3, then an additional metric-association rule, [M₁, M₂, M₄], is created.

Each metric-association rule of interest corresponds to a particular performance problem with the service provided by the distributed application. In particular, the metric-association rule identifies the metrics of resources and/or objects that contribute to the performance problem. As a result, the metric-association rule can be used to identify resources and/or objects that are the root cause of the performance problem. The operations manager computes a rank for each metric-association rule based on one or more of the participation rate, KPI degradation rate, and the co-occurrence rate in Equations (22)-(24). Examples of rank functions that may be used to compute a rank of a metric-association rule are given by

Rank(metric−ass rule)=XYZ(28a)

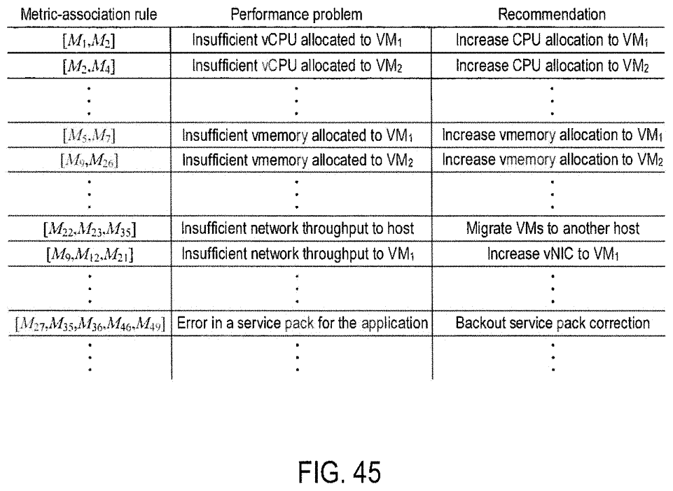

Rank(metric−ass rule)=aX+bY+cZ (28b)
where
   X=Pᵣₐₜₑ(metric−ass rule);
   Y=SLOmetric_{deg_rate}(metric−ass rule);
   Z=Co_{index}(metric−ass rule); and
   a, b, and c are non-negative weights.
      The metric-association rule with the largest rank function value is used to identify the root cause of the performance problem and generate a recommendation for correcting the performance problem. In other words, the metrics comprising the metric-association rule correspond to abnormally behaving resources and/or objects of the distributed application, which identify the root cause of the performance problem. The operations manager displays the root cause of the performance problem and the recommendation in a GUI as described below with reference to FIG. 45.

In an alternative implementation, the operations manager determines metric-association rules for a KPI based on outlier metric values of the KPI and each of the metrics of resources and objects of a distributed application. For each metric of an object or tier, the operations manager constructs metric and KPI tuples for the same time stamps within a run-time window:

C={(x₁,x₁^{KPI}),(x₂,x₂^{KPI}), . . . ,(x_{Q},x_{Q}^{KPI})} (29)
where

M=(xᵢ)ᵢ₌₁^{Q}; and

KPI=(xᵢ^{KPI})ᵢ₌₁^{Q}.

The operations manager computes the distance between each pair of tuples in the set C as follows:

d(i,j)=\sqrt{(xᵢ−xⱼ)²+(xᵢ^{KPI}−xⱼ^{KPI})²} (30)

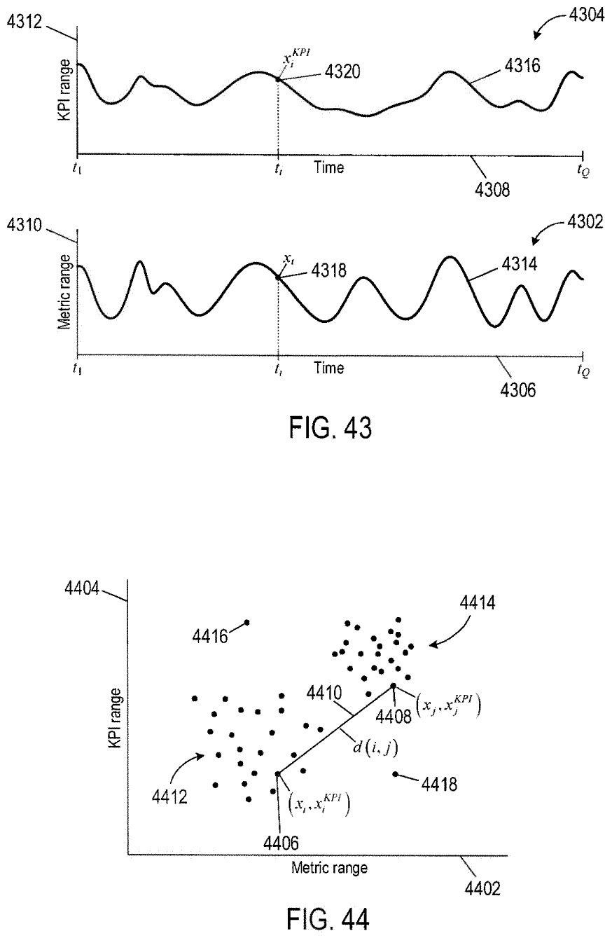

FIG. 43 shows plot 4302 of an example metric and a plot 4304 of an example KPI. Horizontal axes 4306 and 4308 represent the same run-time window. Vertical axis 4310 represents range of values for the metric. Vertical axis 4312 represents a range of values for the metric. Curve 4314 represents metric values of the metric. Curve 4316 represents values of the KPI. Metric and KPI tuples are formed from KPI values and metric values at the same time stamps. For example, metric value 4318 and KPI value 4320 have the same time stamp tᵢ and form a metric and KPI tuple denoted by (xᵢ, xᵢ^{KPI}).

FIG. 44 shows a two-dimensional space that contains the set of metric and KPI tuples. Axis 4402 represents the range of values for the metric. Axis 4404 represents the range of values for the KPI. Points in the space represent metric and KPI tuples. For example, point 4406 represents the metric and KPI tuple (xᵢ, xᵢ^{KPI}) and point 4408 represents the metric and KPI tuple (xⱼ, xⱼ^{KPI}). Line 4410 represents the distance between the points 4406 and 4408. Note that metric and KPI tuples show dense regions, or clusters. 4412 and 4414, which suggest that metric and KPI tuples in these clusters are related or share similar characteristics. By contrast, points 4416 and 4418 are located away from the clusters 4412 and 4414, indicating that the metric and KPI tuples at points 4416 and 4418 do not share similar characteristics with tuples in the clusters 4412 and 4414. The points 4416 and 4418 are regarded as outliers.

The operations manager performs local outlier detection, which is an unsupervised machine learning technique for detection of outliers. The operations manager computes a distance d(i, j) between each of pair metric and KPI values, for i=1, 2, . . . , Q−1 j=i+1, . . . , Q, and j≈i. The distances are rank ordered from largest to smallest. Let K denote a user-selected positive integer. The operations manager determines the K-distance, denoted dist_{K}(i), which is the distance between the metric and KPI tuple (xᵢ, xᵢ^{KPI}) and the K-th nearest neighboring tuple to the metric and KPI tuple (xᵢ, xᵢ^{KPI}). The operations manager forms a K-distance neighborhood of metric and KPI tuples with distances to the metric and KPI tuple (xᵢ, xᵢ^{KPI}) that are less than or equal to the K-distance:

N_{K}(i)={(xⱼ,xⱼ^{KPI})∈C\{(xᵢ,xᵢ^{KPI})}|dist(i,j)≤dist_{K}(i)} (31)

A local reachability density is computed for the point (xᵢ, xᵢ^{KPI}) as follows:

$$lrd ( i ) = \frac{‖ {N}_{K} ( i ) ‖}{{\sum }_{( {x}_{j} , {x}_{j}^{KPI} ) ∈ {N}_{K} ( i )} reach - {dist}_{K} ( i , j )} \qquad ( 32 )$$

where
   ∥N_{K}(i)∥ is the number of tuples in the K-distance neighborhood N_{K}(i); and
   reach−dist_{K}(i, j) is the reachability distance between the tuple (xᵢ, xᵢ^{KPI}) and the tuple (xⱼ, xⱼ^{KPI}).
      The reachability distance in Equation (32) is given by:

reach−dist_{K}(i,j)=max{dist_{K}(i),dist(i,j)} (33)
where j=1, . . . , Q and j≈i.
   A local outlier factor (“LOF”) is computed for the tuple (xᵢ, xᵢ^{KPI}) as follows:

$$LOF ( i ) = \frac{{\sum }_{( {x}_{j} , {x}_{j}^{KPI} ) ∈ {N}_{K} ( i )} lrd ( j )}{‖ {N}_{K} ( i ) ‖} \times \frac{1}{lrd ( i )} \qquad ( 34 )$$

The LOF of Equation (34) is an average local reachability density of the neighboring metric and KPI tuples divided by the local reachability density. An LOF is computed for each tuple (xᵢ, xᵢ^{KPI}) in C. Tuples with LOF's greater than a local outlier threshold (i.e., LOF(i)>Th_{LOF}) are considered outliers. For the local outlier threshold equals 1, 0.95, or 0.9. When the number of outliers for a metric is greater than an outlier threshold, the metric is not related to or does not share characteristics with the KPI. On the other hand, when the number of outliers for a metric is less than the outlier threshold, the metric shares characteristics with the KPI. The operations represented by Equations (30)-(34) are repeated for each metric associated with an object or tier. The one or more metrics that are related to or share characteristics with the KPI form a metric-association rule as described above. The combination of metrics that form the metric-association rule identify the resources and/or objects behind the performance problem and are used to generate a recommendation for correcting the problem observed in the KPI as described below with reference to FIG. 45.

Each metric-association rule identifies metrics that correspond to abnormally behaving resources and or objects of the distributed application. The operations manager uses the metrics-association rule to identify a root cause of the performance problem and generate a recommendation for correcting the performance problem and displays the performance problem and the recommendation in a GUI.

FIG. 45 shows a table of example metric-association rules stored in a data storage device and accessed by the operations manager to report performance problems and generate recommendations for correcting the performance problem. Each metric-association rule identifies a particular set of metrics and is associated with a specific performance problem and a recommendation for correcting the performance problem. Each set of metrics corresponds to resources and/or objects. When the operations manager detects a KPI performance problem (e.g., SLO threshold violation) the operations manager determines a metric-association rule as described above. The operations manager compares the metric-association rule to the metric-association rules in the table and when a match is identified, the operations manager displays the root cause of the corresponding performance problem and a recommendation in a GUI and enables the user to execute the recommendation to correct the problem in the form of pre-programmed script programs, sequences of computer-implemented instructions, or application programming interfaces (“APIs”) that automatically execute remedial measures in accordance with the recommendations. Suppose a metric-associated rule corresponds to a recommendation to increase CPU allocation to a distributed application exhibiting a slow response time KPI. The operations manager may execute remedial measures that increases CPU allocation to VMs of the application. In another example, a metric-associated rule corresponds to a recommendation to increase network bandwidth to the host of VMs of a distributed application. The operations manager may execute remedial measures that automatically reconfigure a virtual network used by the VMs of the application or migrate VMs, or containers, that execute software components of the application from one server computer to another server computer with more CPU, memory, and/or networking capabilities. Automated remedial measures that may be executed in response to metric-association rules include powering down server computers, replacing VMs disabled by physical hardware problems and failures, spinning up cloned VMs on additional server computers to ensure that software components of the distributed application are accessible to an increasing demand for services.

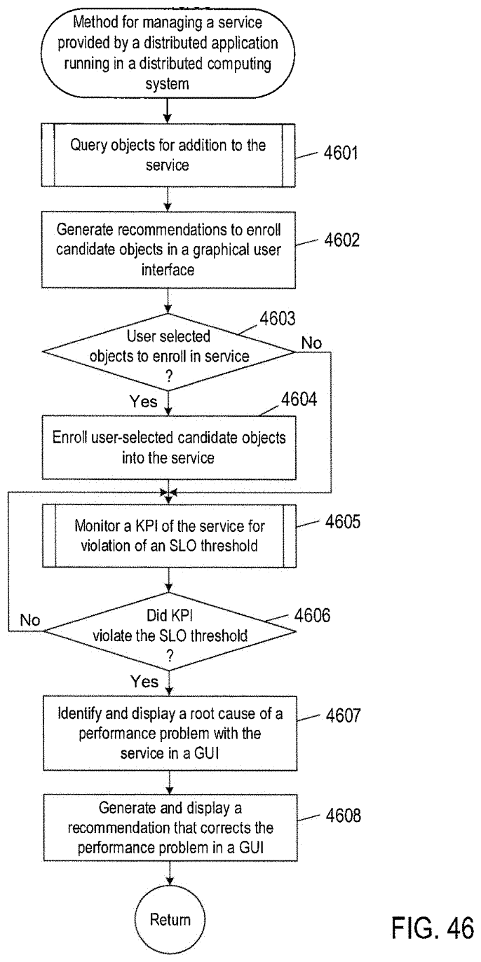

The methods described below with reference to FIGS. 46-51 are stored in one or more data-storage devices as machine-readable instructions and are executed by one or more processors of a computer system, such as a computer system represented in FIG. 1.

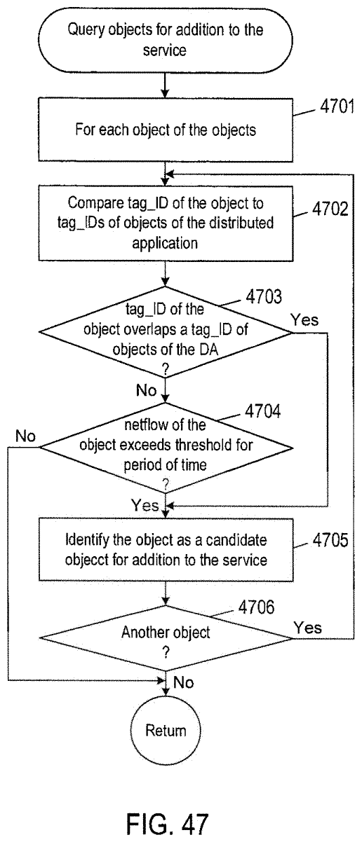

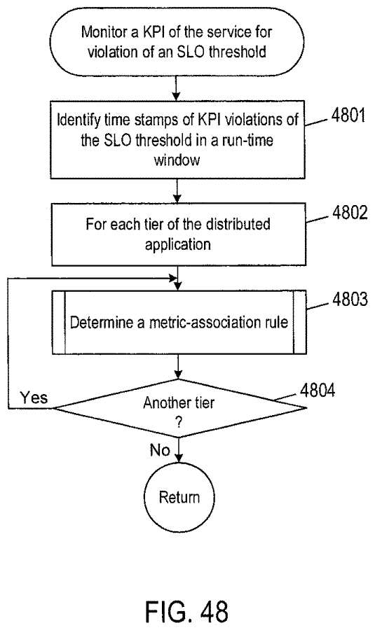

FIG. 46 is a flow diagram of a method for managing a service provided by a distributed application running in a distributed computing system. In block 4601, a “query objects for addition to the service” procedure is performed. An example implementation of the “query objects for addition to the service” procedure is described below with reference to FIG. 47. In block 4602, recommendations to enroll candidate objects in a GUI are generated as described above with reference to FIGS. 19 and 22. In decision block 4603, when a user selects one or more of the candidate objects in the GUI, control flows to block 4604. In block 4604, user-selected candidate objects are enrolled into the service as described above with reference to FIGS. 20A-20B and 23A-23B. In block 4605, a “monitor a KPI of the service for violation of an SLO threshold” procedure is performed on run-time KPI values. An example implementation of the “monitor a KPI of the service for violation of an SLO threshold” procedure is described below with reference to FIG. 48. In decision block 4606, when the KPI violates the corresponding SLO threshold, control flows to block 4607. In block 4607, a root cause of a performance problem with the service is identified and displayed in a GUI as described above with reference to FIG. 45. In block 4608, a recommendation to correct the performance problem is generated and displayed in the GUI.

FIG. 47 is a flow diagram illustrating an example implementation of the “query objects for addition to the service” procedure performed in block 4601. A loop beginning with block 4701 repeats the computational operations represented by blocks 4702-4706 for each object of the objects identified in block 4601. In block 4702, the tag_ID of the object is compared with the tag_IDs of the objects of the distributed application. In decision block 4703, when the tag_ID of the object overlaps a tag_ID of the objects of the distributed application as described above with reference to FIGS. 17A-17D, control flows to block 4705. Otherwise, control flows to decision block 4704. In decision block 4704, when the netflow of the object exceeds a threshold for a period of time, control flows to block 4705 as described above with reference to FIGS. 21B and 21C. In block 4705, the object is identified as a candidate object for addition to the service. In decision block 4706, blocks 4702-4705 are repeated for an object.

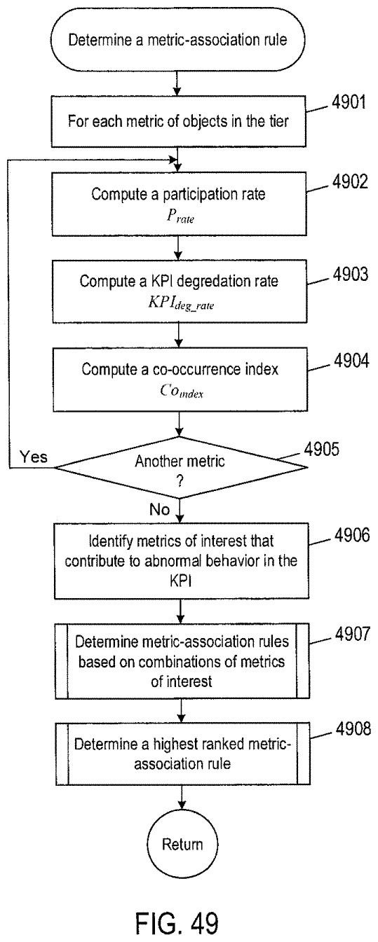

FIG. 48 is a flow diagram illustrating an example implementation of the “monitor a KPI of the service for violation of an SLO threshold” procedure performed in block 4605. In block 4801, time stamps of KPI violations of the SLO threshold are identified in a run-time window as described above with reference to FIG. 36. A loop beginning with block 4802 repeats the computational operation represented in block 4803 for each object of a tier of the distributed application. In block 4803, a “determine a metric-association rule” procedure is performed. An example implementation of the “determine a metric-association rule” procedure is described below with reference to FIG. 49. In decision block 4804, the computational operation of block 4803 is repeated for another tier.

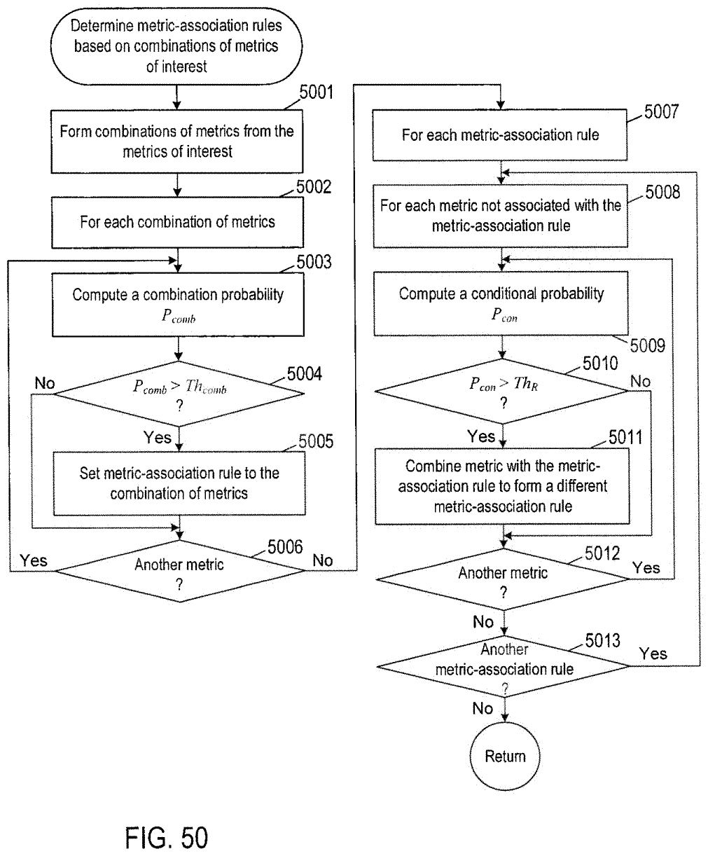

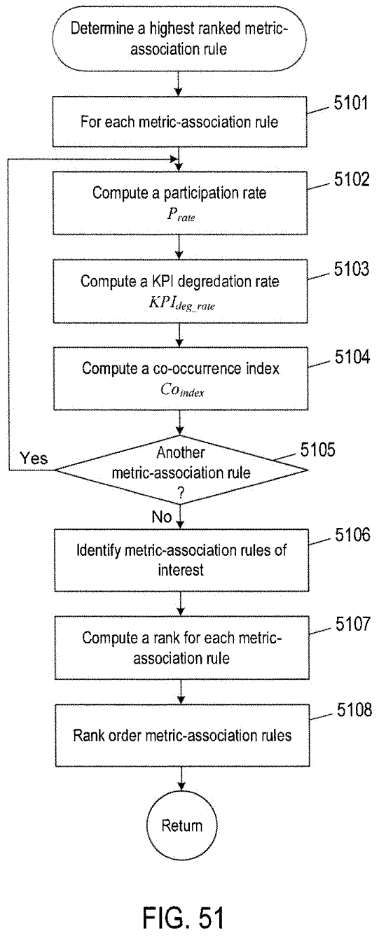

FIG. 49 is a flow diagram illustrating an example implementation of the “determine a metric-association rule” procedure performed in block 4803. A loop beginning with block 4901 repeats the computational operations represented by blocks 4902-4904 is repeated for each metric of objects in the tier. In block 4902, a participation rate is computed as described above with reference to Equation (16). In block 4903, a degradation rate of the KPI is computed as described above with reference to Equation (17). In block 4904, a co-occurrence rate is computed as described above with reference to Equation (18). In decision block 4905, blocks 4902-4904 are repeated for another metric. In block 4906, metrics that satisfy one or more of the conditions in Equations (19a)-(19c) are identified as metrics of interest. In block 4907, a “determine metric-association rules based on combinations of metrics of interest” procedure is performed. An example implementation of the “determine a metric-association rule based on combinations of metrics of interest” procedure is described below with reference to FIG. 50. In block 4908, a “determine a highest ranked metric association rule” procedure is performed. An example implementation of the “determine a highest ranked metric association rule” procedure is described below with reference to FIG. 51.

FIG. 50 is a flow diagram illustrating an example implementation of the “determine metric-association rules based on combinations of metrics of interest” procedure performed in block 4907. In block 5001, combinations of metric from the metrics of interest are formed as described above with reference to FIG. 40. A loop beginning with block 5002 repeats the computational operations for each combination of metrics formed in block 5001. In block 5003, a combination probability for the combination of metrics is computed as described above with reference to Equation (20). In a decision block 5004, when the combination probability is greater than a combination threshold, control flows to block 5005. In block 5005, the metric-association rule is set to the combination of metrics. In a decision block 5006, the operations represented by blocks 5003-5005 is repeated for each metric. Otherwise, control flows to block 5007. A loop beginning with block 5007 repeats the computational operations represented by blocks 5008-5012 for each of the metric-association rules obtained in blocks 5003-5005. A loop beginning with block 5008 repeats the computational operations of blocks 5009-5011 for each metric not included in the metric-association rule. In block 5009, a conditional probability is computed for the metric as described above with reference to Equation (25). In a decision block 5010, when the conditional probability is greater than a conditional-probability threshold, control flows to block 5011. In a block 5011, the metric is combined with metric-association rule to form a different metric-association rule as described above with reference to Equation (26). In a decision block 5012, the operations represented by blocks 5009-5011 for another metric. In a decision block 5013, the operations represented by blocks 5008-5012 for another metric-association rule.

FIG. 51 is a flow diagram illustrating an example implementation of the “determine a highest ranked metric association rule” procedure performed in block 4908. A loop beginning with block 5101 repeats the computational operations represented by blocks 5102-5104 for each metric-association rule obtained in block 4907. In block 5102, a participation rate is computed for the metric-association rule as described above Equation (22). In block 5103, a KPI degradation rate is computed for the metric-association rule as described above Equation (22). In block 5104, a co-occurrence rate is computed for the metric-association rule as described above Equation (24). In decision block 5105, the operations represented by blocks 5102-5104 are repeated for another metric-associated rule. In block 5106, metric-association rules that are of interest are identified as described above with reference to Equations (25a)-(25c). In block 5107, a rank is computed for each of the metric-association rules that are of interest as described above with reference to Equations (28a)-(28b). In block 5108, the metric-association rules are rank ordered and the highest rank ordered metric-association rule is used to identify a performance problem and recommendation for correcting the problem as described above with reference to FIG. 45.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An automated computer-implemented process that manages a service provided by a distributed application running in a distributed computing system, the process comprising:
querying objects of the distributed computing system to identify candidate objects for addition to the service based on metadata of the objects or run-time netflows between the objects and objects of the distributed application;
enrolling one or more of the candidate objects into the service in response to a user selecting the one or more candidate objects via a graphical user interface (“GUI”);
monitoring a key performance indicator (“KPI”) of the service for violation of a corresponding service level object (“SLO”) threshold; and
in response to detecting the KPI violation of the SLO threshold at run time, determining a root cause of a performance problem with the service based on a metric-association rule associated with the KPI violation of the SLO threshold, and displaying the root cause of the performance problem and a recommendation that corrects the performance problem in a GUI.

2. The process of claim 1 wherein querying objects running in the distributed computing system comprises:
for each of the objects running in the distributed computing system,
comparing a tag identifier (“ID”) of the object with tag identifiers of objects of the distributed application;
identifying the object as a candidate object for addition to the service when the tag ID of the object overlaps tag IDs of the objects of the distributed application; and
identifying the object as a candidate object for addition to the service when the netflow between the object and one or more objects of the distributed application exceed a netflow threshold for a period of time.

3. The process of claim 1 wherein enrolling one or more of the candidate objects into the service comprises generating a recommendation to enroll the candidate objects into the service in the GUI, the GUI providing fields that enable a user to select from the one or more candidate objects to enroll in the service.

4. The process of claim 1 wherein monitoring the KPI of the service for violation of the corresponding SLO threshold comprises:
providing a GUI that enables a user to select a metric that serves as the KPI and an SLO threshold for the KPI; and
providing a GUI that enables a user to select alert conditions for metrics of the distributed application.

5. The process of claim 1 wherein monitoring the KPI of the service for violation of the corresponding SLO threshold comprises:
identifying time stamps of KPI violations of the SLO threshold in a run-time interval; and
for each tier of the distributed application, determining a metric-association rule that is associated with the KPI violation of the SLO threshold.

6. The process of claim 5 wherein determining the metric-association rule that is associated with the KPI violation of the OLS threshold comprises:
for each metric of objects of the distributed application,
computing at least one of a participation rate, a KPI degradation rate, and a co-occurrence index, and
identifying metrics of interest that contribute to abnormal behavior in the KPI based on the at least one participation rate, KPI degradation rate, and co-occurrence index exceeding corresponding thresholds;
determining metric-association rules based on combinations of the metrics of interest;
for each metric-association rule,
computing at least one of a participation rate, a KPI degradation rate, and a co-occurrence index for the metric-association rule, and
identifying metric-associations rules of interest based on the at least one participation rate, KPI degradation rate, and co-occurrence index exceeding corresponding thresholds;
determining a rank for each of the metric-association rules of interest; and
determining the metric-association rule associated with the KPI violation of the SLO threshold as the highest ranked of the metric-associations rules of interest.

7. The process of claim 6 wherein determining the metric-association rules comprises:
forming combinations of metrics from the metrics of interest;
computing a combination probability for each combination of metrics; and
for each combination probability that exceeds a combination probability threshold, setting a corresponding metric-association rule equal to the combination of metrics with a combination probability that exceeds the combination probability threshold.

8. The process of claim 5 wherein determining the metric-association rule that is associated with the KPI violation of the OLS threshold comprises:
for each metric of objects of the distributed application, computing local outlier factors for the metric; and
forming a metric-association rule from metrics with local outlier factors that are greater than a local outlier threshold.

9. A computer system for creating, discovering, and managing services in a distributed computing system, the system comprising:
one or more processors;
one or more data-storage devices; and
machine-readable instructions stored in the one or more data-storage devices that when executed using the one or more processors controls the system to execute operations comprising:
querying objects of the distributed computing system to identify candidate objects for addition to the service based on metadata of the objects or run-time netflows between the objects and objects of the distributed application;
enrolling one or more of the candidate objects into the service in response to a user selecting the one or more candidate objects via a graphical user interface (“GUI”);
monitoring a key performance indicator (“KPI”) of the service for violation of a corresponding service level object (“SLO”) threshold; and
in response to detecting the KPI violation of the SLO threshold, determining a root cause of a performance problem with the service based on a metric-association rule associated with the KPI violation of the SLO threshold, and displaying the root cause of the performance problem and a recommendation that corrects the performance problem in a GUI.

10. The computer system of claim 9 wherein querying objects running in the distributed computing system comprises:
for each of the objects running in the distributed computing system,
comparing a tag identifier (“ID”) of the object with tag identifiers of objects of the distributed application;
identifying the object as a candidate object for addition to the service when the tag ID of the object overlaps tag IDs of the objects of the distributed application; and
identifying the object as a candidate object for addition to the service when the netflow between the object and one or more objects of the distributed application exceed a netflow threshold for a period of time.

11. The computer system of claim 9 wherein enrolling one or more of the candidate objects into the service comprises generating a recommendation to enroll the candidate objects into the service in the GUI, the GUI providing fields that enable a user to select from the one or more candidate objects to enroll in the service.

12. The computer system of claim 9 wherein monitoring the KPI of the service for violation of the corresponding SLO threshold comprises:
providing a GUI that enables a user to select a metric that serves as the KPI and an SLO threshold for the KPI; and
providing a GUI that enables a user to select alert conditions for metrics of the distributed application.

13. The computer system of claim 9 wherein monitoring the KPI of the service for violation of the corresponding SLO threshold comprises:
identifying time stamps of KPI violations of the SLO threshold in a run-time interval; and
for each tier of the distributed application, determining a metric-association rule that is associated with the KPI violation of the SLO threshold.

14. The computer system of claim 13 wherein determining the metric-association rule that is associated with the KPI violation of the OLS threshold comprises:
for each metric of objects of the distributed application,
computing at least one of a participation rate, a KPI degradation rate, and a co-occurrence index, and
identifying metrics of interest that contribute to abnormal behavior in the KPI based on the at least one participation rate, KPI degradation rate, and co-occurrence index exceeding corresponding thresholds:
determining metric-association rules based on combinations of the metrics of interest;
for each metric-association rule,
computing at least one of a participation rate, a KPI degradation rate, and a co-occurrence index for the metric-association rule, and
identifying metric-associations rules of interest based on the at least one participation rate, KPI degradation rate, and co-occurrence index exceeding corresponding thresholds;
determining a rank for each of the metric-association rules of interest; and
determining the metric-association rule associated with the KPI violation of the SLO threshold as the highest ranked of the metric-associations rules of interest.

15. The computer system of claim 14 wherein determining the metric-association rules comprises:
forming combinations of metrics from the metrics of interest;
computing a combination probability for each combination of metrics; and
for each combination probability that exceeds a combination probability threshold, setting a corresponding metric-association rule equal to the combination of metrics with a combination probability that exceeds the combination probability threshold.

16. The computer system of claim 13 wherein determining the metric-association rule that is associated with the KPI violation of the OLS threshold comprises:
for each metric of objects of the distributed application, computing local outlier factors for the metric; and
forming a metric-association rule from metrics with local outlier factors that are greater than a local outlier threshold.

17. A non-transitory computer-readable medium encoded with machine-readable instructions that control one or more processors of a computer system to perform operations comprising:
querying objects of the distributed computing system to identify candidate objects for addition to the service based on metadata of the objects or run-time netflows between the objects and objects of the distributed application;
enrolling one or more of the candidate objects into the service in response to a user selecting the one or more candidate objects via a graphical user interface (“GUI”);
monitoring a key performance indicator (“KPI”) of the service for violation of a corresponding service level object (“SLO”) threshold; and
in response to detecting the KPI violation of the SLO threshold, determining a root cause of a performance problem with the service based on a metric-association rule associated with the KPI violation of the SLO threshold, and displaying the root cause of the performance problem and a recommendation that corrects the performance problem in a GUI.

18. The medium of claim 17 wherein querying objects running in the distributed computing system comprises:
for each of the objects running in the distributed computing system,
comparing a tag identifier (“ID”) of the object with tag identifiers of objects of the distributed application;
identifying the object as a candidate object for addition to the service when the tag ID of the object overlaps tag IDs of the objects of the distributed application; and
identifying the object as a candidate object for addition to the service when the netflow between the object and one or more objects of the distributed application exceed a netflow threshold for a period of time.

19. The medium of claim 17 wherein enrolling one or more of the candidate objects into the service comprises generating a recommendation to enroll the candidate objects into the service in the GUI, the GUI providing fields that enable a user to select from the one or more candidate objects to enroll in the service.

20. The medium of claim 17 wherein monitoring the KPI of the service for violation of the corresponding SLO threshold comprises:
providing a GUI that enables a user to select a metric that serves as the KPI and an SLO threshold for the KPI; and
providing a GUI that enables a user to select alert conditions for metrics of the distributed application.

21. The medium of claim 17 wherein monitoring the KPI of the service for violation of the corresponding SLO threshold comprises:
identifying time stamps of KPI violations of the SLO threshold in a run-time interval; and
for each tier of the distributed application, determining a metric-association rule that is associated with the KPI violation of the SLO threshold.

22. The medium of claim 21 wherein determining the metric-association rule that is associated with the KPI violation of the OLS threshold comprises:
for each metric of objects of the distributed application,
computing at least one of a participation rate, a KPI degradation rate, and a co-occurrence index, and
identifying metrics of interest that contribute to abnormal behavior in the KPI based on the at least one participation rate, KPI degradation rate, and co-occurrence index exceeding corresponding thresholds;
determining metric-association rules based on combinations of the metrics of interest;
for each metric-association rule,
computing at least one of a participation rate, a KPI degradation rate, and a co-occurrence index for the metric-association rule, and
identifying metric-associations rules of interest based on the at least one participation rate, KPI degradation rate, and co-occurrence index exceeding corresponding thresholds;
determining a rank for each of the metric-association rules of interest; and
determining the metric-association rule associated with the KPI violation of the SLO threshold as the highest ranked of the metric-associations rules of interest.

23. The medium of claim 22 wherein determining the metric-association rules comprises:
forming combinations of metrics from the metrics of interest;
computing a combination probability for each combination of metrics; and
for each combination probability that exceeds a combination probability threshold, setting a corresponding metric-association rule equal to the combination of metrics with a combination probability that exceeds the combination probability threshold.

24. The medium of claim 21 wherein determining the metric-association rule that is associated with the KPI violation of the OLS threshold comprises:
for each metric of objects of the distributed application, computing local outlier factors for the metric; and
forming a metric-association rule from metrics with local outlier factors that are greater than a local outlier threshold.
